(19) United States
(12) Patent Application Publication
(10) Pub. No.: US 2015/0102746 A1
(43) Pub. Date: Apr. 16, 2015

(54) LIGHTING DEVICE CONTROL USING VARIABLE INDUCTOR

(71) Applicant: SureFire, LLC, Fountain Valley, CA (US)

(72) Inventors: William A. Hunt, Foothill Ranch, CA (US); Loc Nguyen, Santa Ana, CA (US); Ammar Burayez, Silverado, CA (US); John W. Matthews, Newport Beach, CA (US)

(21) Appl. No.: 14/578,201

(22) Filed: Dec. 19, 2014

Related U.S. Application Data
(63) Continuation-in-part of application No. 13/570,820, filed on Aug. 9, 2012.
(60) Provisional application No. 61/926,785, filed on Jan. 13, 2014.
(60) Provisional application No. 61/926,233, filed on Jan. 10, 2014.
(60) Provisional application No. 61/524,734, filed on Aug. 17, 2011.

(51) Int. Cl. H05B 37/02

(52) U.S. Cl. CPC H05B 37/02
USPC 315/291

(57) ABSTRACT

Various techniques are provided for implementing a variable control for a lighting device, such as a flashlight, that uses a variable inductor. The lighting device may include a tail cap, a battery terminal, and a variable inductor mounted in the tail cap and electrically connected in series with the battery terminal. The lighting device may also include a user operable switch configured to selectively bypass the variable inductor. The variable inductor may include, for example, a magnetic coil comprising a wire coil and a core. The variable inductor may also include a ring comprised of ferrous material and having a substantially elliptical inner circumfery and surrounding the magnetic coil, wherein the ring is adapted to be rotated relative to the magnetic coil in response to user actuation of a rotatable user control.

### CROSS-REFERENCE TO RELATED APPLICATIONS

This application claims the benefit of U.S. Provisional Patent Application No. 61/926,785 filed Jan. 13, 2014, which is hereby incorporated by reference in its entirety.

This application claims the benefit of U.S. Provisional Patent Application No. 61/926,233 filed Jan. 10, 2014, which is hereby incorporated by reference in its entirety.

This application is a continuation-in-part of U.S. patent application Ser. No. 13/570,820 filed Aug. 9, 2012, which claims the benefit of U.S. Provisional Patent Application No. 61/524,734 filed Aug. 17, 2011, all of which are hereby incorporated by reference in their entirety.

### BACKGROUND

1. Field of the Invention

The present disclosure generally relates to lighting devices, and more particularly to controls for lighting devices.

2. Related Art

Various types of lighting devices may be used to illuminate areas of interest. For example, portable lighting devices are often used by law enforcement, military personnel, emergency/medical personnel, divers, hikers, search/rescue teams, and other users.

Many existing portable lighting devices have conventional switches that allow a user to adjust the brightness or other functions of the lighting devices. However, the number of settings available using conventional switches is often limited, and such configurations may hamper the functionality of the lighting devices. For example, lighting devices with only two brightness settings may not provide a sufficient number of illumination levels in different lighting conditions. While switches with multiple settings are available, they often require costly mechanical configurations, may require the user to change hand positions, or may require a second hand to operate.

Accordingly, there is a need for an improved lighting device that overcomes one or more of the deficiencies discussed above.

### SUMMARY

In accordance with various embodiments described herein, a variable control for a lighting device may be implemented with a variable inductor. In various embodiments, the variable control may be implemented with a plurality of continuous or stepped settings. The variable control may be adjusted by a user-actuated movement of a part of the lighting device, such as the depression of a tail cap or another appropriate physical control to change the inductance of the variable inductor. An oscillating signal may be induced in a variable inductor circuit that includes the variable inductor. The oscillating signal may exhibit characteristics, such as frequency, that change with the inductance of the variable inductor. Such characteristics may be measured to determine a setting of the variable control and which may be used to adjust the brightness or other attributes of the lighting device.

In one embodiment, a lighting device includes a light source; and a variable control adapted to provide a plurality of control settings, wherein the variable control comprises: a physical control adapted to be selectively positioned by a user, a variable inductor circuit adapted to exhibit a change in inductance based on the physical control, and a control circuit adapted to induce an oscillating signal in the variable inductor circuit, measure the oscillating signal to determine a control setting associated with the change in inductance, and control the light source using the determined control setting, wherein the oscillating signal changes with the inductance of the variable inductor circuit.

In another embodiment, a method of operating a lighting device includes receiving a user manipulation of a physical control that causes a variable inductor circuit to exhibit a change in inductance; inducing an oscillating signal in the variable inductor circuit, wherein the oscillating signal changes with the inductance of the variable inductor circuit; measuring the oscillating signal to determine a control setting associated with the change in inductance; and controlling a light source using the determined control setting.

In another embodiment, a lighting device may include a tail cap, a battery terminal, and a variable inductor mounted in (e.g., completely in or substantially in) the tail cap and electrically connected in series with the battery terminal. The lighting device may also include a user operable switch configured to selectively bypass the variable inductor. The variable inductor may include, for example, a magnetic coil comprising a wire coil and a core. The variable inductor may also include a ring comprised of ferrous material and having a substantially elliptical inner circumfery and surrounding the magnetic coil, wherein, the ring is adapted to be rotated relative to the magnetic coil in response to user actuation of a rotatable user control. An activation circuit may be provided that repeatedly introduces oscillating signals having a frequencies dependent on the inductance exhibited by the variable inductor and/or the state of the user operable switch. The oscillating signals may be detected and used to provide substantially continuous and/or switched user control signals.

The scope of the invention is defined by the claims, which are incorporated into this section by reference. A more complete understanding of embodiments of the disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE FIGURES OF THE DRAWINGS

FIG. 1 illustrates a cross sectional view of a lighting device including a variable control using a variable inductor in accordance with an embodiment of the disclosure.

FIG. 2 illustrates a schematic of a variable control circuit implemented by a variable inductor circuit connected to a control circuit through at least one conductive wire in accordance with an embodiment of the disclosure.

FIG. 3 illustrates waveforms of several oscillating signals of a variable inductor circuit generated in response to a pulse in accordance with an embodiment of the disclosure.

FIG. 4 illustrates a schematic of another variable control circuit implemented by another variable inductor circuit connected to another control circuit through a battery in accordance with an embodiment of the disclosure.

FIG. 5 illustrates a flow chart of steps for measuring a frequency of an oscillating signal to detect a switch setting of a variable control when a decaying time of the oscillating signal is less than a minimum measurement interval in accordance with an embodiment of the disclosure.

FIG. 6 is an upper, front and left side perspective view of an example lighting device in accordance with an embodiment of the disclosure.

FIG. 7 is an exploded front and left side perspective view of the example lighting device of FIG. 6 in accordance with an embodiment of the disclosure.

FIG. 8 is a cross-sectional view of the lighting device, as seen along the lines of the section 8-8 taken in FIG. 6 in accordance with an embodiment of the disclosure.

FIG. 9A is an enlarged view of a portion of the cross-section shown FIG. 8 in accordance with an embodiment of the disclosure.

FIG. 9B is an enlarged perspective view of a portion of the cross-section shown in FIG. 8 in accordance with an embodiment of the disclosure.

FIG. 10A is a front and left side perspective view of an example tail cap wiring assembly of the example lighting device in accordance with an embodiment of the disclosure.

FIG. 10B is a rear and left side perspective view of the example tail cap wiring assembly of FIG. 10A in accordance with an embodiment of the disclosure.

FIG. 11A is a front end elevation view of a variable inductor and a rotatable user control of the lighting device in accordance with an embodiment of the disclosure.

FIG. 11B is a front end elevation view of the variable inductor and rotatable user control, showing a ferrous ring rotated clockwise through an angle of about 90 degrees relative to the position of the ring shown in FIG. 11A in accordance with an embodiment of the disclosure.

FIG. 12A is bottom and left side perspective view of a magnetic coil of FIGS. 11A and 11B in accordance with an embodiment of the disclosure.

FIG. 12B is an end view of the magnetic coil in accordance with an embodiment of the disclosure.

FIG. 12 C is a top and left side perspective view of the magnetic coil in accordance with an embodiment of the disclosure.

FIG. 13A is a front and left side perspective view of the ring of FIGS. 11A and 11B in accordance with an embodiment of the disclosure.

FIG. 13B is a side elevation view of the ring in accordance with an embodiment of the disclosure.

FIG. 13C is a rear end elevation view of the ring in accordance with an embodiment of the disclosure.

FIG. 14A is a front and left side perspective view of an example rotatable user control within which the ring is fixed for conjoint circumferential rotation and which is turned by a user to adjust the inductance of the variable inductor to control the lighting device in accordance with an embodiment of the disclosure.

FIG. 14B is a front end view of the rotatable user control in accordance with an embodiment of the disclosure.

FIG. 14C is a left side elevation view of the rotatable user control in accordance with an embodiment of the disclosure.

FIG. 14D is a rear end view of the rotatable user control in accordance with an embodiment of the disclosure.

FIG. 15A is a front and left side perspective view of an example contact board of the example tail cap wiring assembly of FIGS. 10A and 10B in accordance with an embodiment of the disclosure.

FIG. 15B is a front end view of the contact board in accordance with an embodiment of the disclosure.

FIG. 15C is a left side elevation view of the contact board in accordance with an embodiment of the disclosure.

FIG. 15D is a rear end view of the contact board in accordance with an embodiment of the disclosure.

FIG. 16A is a front and left side perspective view of an example switch board of the example tail cap wiring assembly of FIGS. 10A and 10B in accordance with an embodiment of the disclosure.

FIG. 16B is a front end view of the switch board in accordance with an embodiment of the disclosure.

FIG. 16C is a left side elevation view of the switch board in accordance with an embodiment of the disclosure.

FIG. 16D is a rear end view of the switch board in accordance with an embodiment of the disclosure.

FIG. 17A is a front and left side perspective view of an example contact washer of the example tail cap wiring assembly of FIGS. 10A and 10B in accordance with an embodiment of the disclosure.

FIG. 17B is a front end view of the contact washer in accordance with an embodiment of the disclosure.

FIG. 17C is a left side elevation view of the contact washer in accordance with an embodiment of the disclosure.

FIG. 17D is a rear end view of the contact washer in accordance with an embodiment of the disclosure.

FIG. 18 is a block diagram of various circuitry of the lighting device in accordance with an embodiment of the disclosure.

FIG. 19 is a schematic circuit diagram of an amplitude detection circuit of the lighting device in accordance with an embodiment of the disclosure.

FIG. 20 is a schematic circuit diagram of a conditioning circuit of the lighting device in accordance with an embodiment of the disclosure.

FIG. 21 is a schematic diagram of a measurement circuit of the lighting device in accordance with an embodiment of the disclosure.

FIG. 22 is plot of voltage versus time of various electrical signals of the lighting device when a variable inductor is configured in a low inductance position based on the position of the rotatable user control in accordance with an embodiment of the disclosure.

FIG. 23 is plot of voltage versus time of various electrical signals of the lighting device when a variable inductor is configured in a high inductance position based on the position of the rotatable user control in accordance with an embodiment of the disclosure.

FIG. 24 is plot of voltage versus time of a plurality of electrical signals of the lighting device when a user control switch of the lighting device is depressed in accordance with an embodiment of the disclosure.

FIG. 25 is a schematic circuit diagram of tail cap circuitry in accordance with an embodiment of the disclosure.

Embodiments of the disclosure and their advantages are best understood by referring to the detailed description that follows. It should be appreciated that like reference numerals are used to identify like elements illustrated in one or more of the figures.

### DETAILED DESCRIPTION

Various techniques are provided for implementing and operating variable controls using variable inductors. Such variable controls may be used to provide continuous or stepped control signals to lighting devices such as flashlights, headlamps, or other lighting devices. The variable controls may sense (e.g., detect) changes in inductance caused by user-actuated movements, such as the depression of a tail cap or another appropriate control surface to adjust the brightness or other attributes of the lighting devices. The detected changes may be used to determine one or more settings of the lighting devices and thus control various aspects of the lighting devices, such as the brightness of light sources of the lighting devices, or other aspects.

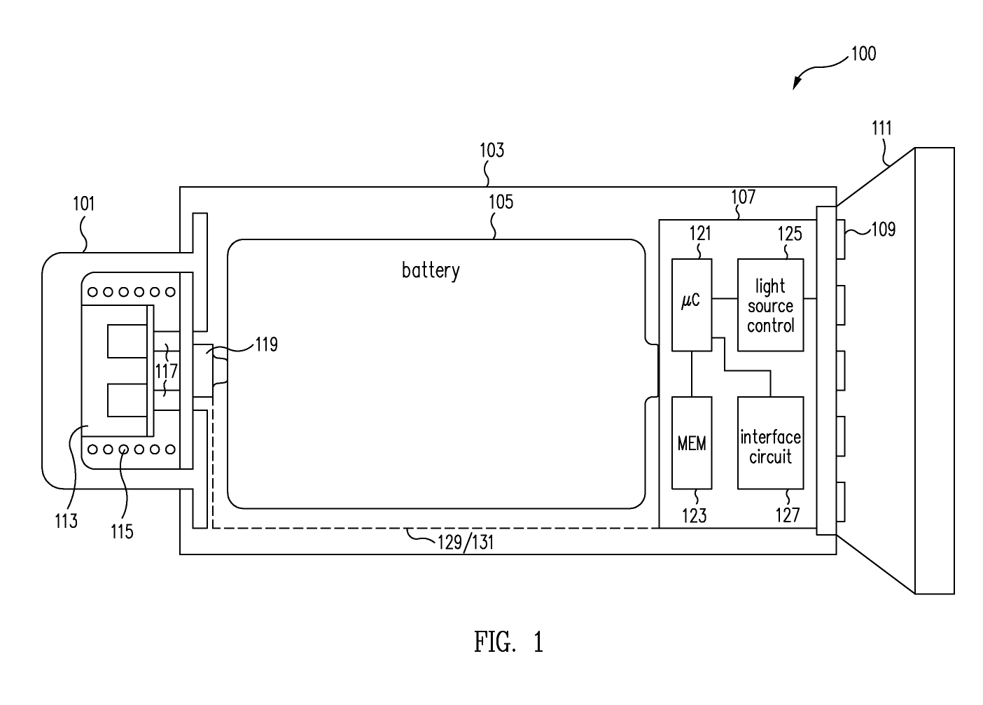

FIG. 1 illustrates a cross sectional view of a lighting device 100 including a variable control using a variable inductor in accordance with an embodiment of the disclosure. In one embodiment, lighting device 100 includes a detachable tail cap 101 that attaches to a body 103 of the lighting device 100. Tail cap 101 may be flexibly coupled to body 103 such that tail cap 101 may be pressed so that it is selectively recessed into body 103 up to a certain depth. In one embodiment, a user may press tail cap 101 so that tail cap 101 is recessed into body 103 by up to 5 mm. Other depression depths may be used in other embodiments. The user may control the setting of the variable control by applying different levels of force to tail cap 101.

Body 103 provides a housing for a battery 105 and a control circuit 107. In one embodiment, control circuit 107 may be positioned near a front end (e.g., head end) of lighting device 100 with battery 105 interposed between tail cap 101 and control circuit 107. In another embodiment, control circuit 107 may be positioned proximate to tail cap 101 near a tail end of lighting device 100. Control circuit 107 includes circuitry for controlling various aspects of lighting device 100 in response to user-actuated movements of a physical control, such as tail cap 101. Control circuit 107 may control power provided to one or more light sources 109 (e.g., light emitting diodes (LEDs), incandescent bulbs, or other light sources) housed in an optical assembly 111. In one embodiment, optical assembly 111 may include a total internal reflection (TIR) lens to reflect light emitted from light sources 109 to project a light beam from lighting device 100. Battery 105 provides power to control circuit 107 and to light sources 109.

Tail cap 101 may have a rubberized outer surface enclosing an inner cavity. Mounted against the inner cavity at the tail end of tail cap 101 is an actuator 113 that is circularly surrounded by a coil of a spring 115 running the depth of the cavity. Spring 115 provides tension force to push against tail cap 101 when a user presses on tail cap 101. Actuator 113 pushes against a magnetic coil 117 whose magnetic field varies with the level of force exerted against magnetic coil 117. As the user pushes on tail cap 101, actuator 113 compresses magnetic coil 117 to change the magnetic field of magnetic coil 117. The changing magnetic field induces a change in the inductance of a variable inductor mounted on a base plate 119. The changing inductance may be sensed by control circuit 107 to detect changes in the settings of the variable control.

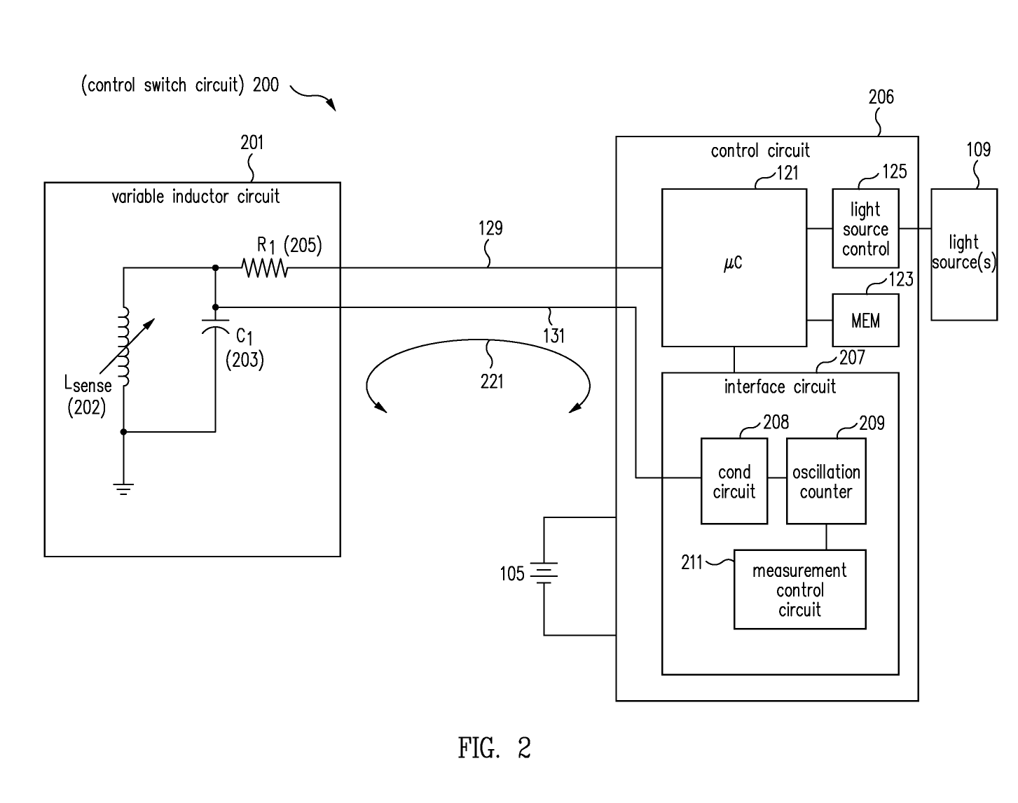

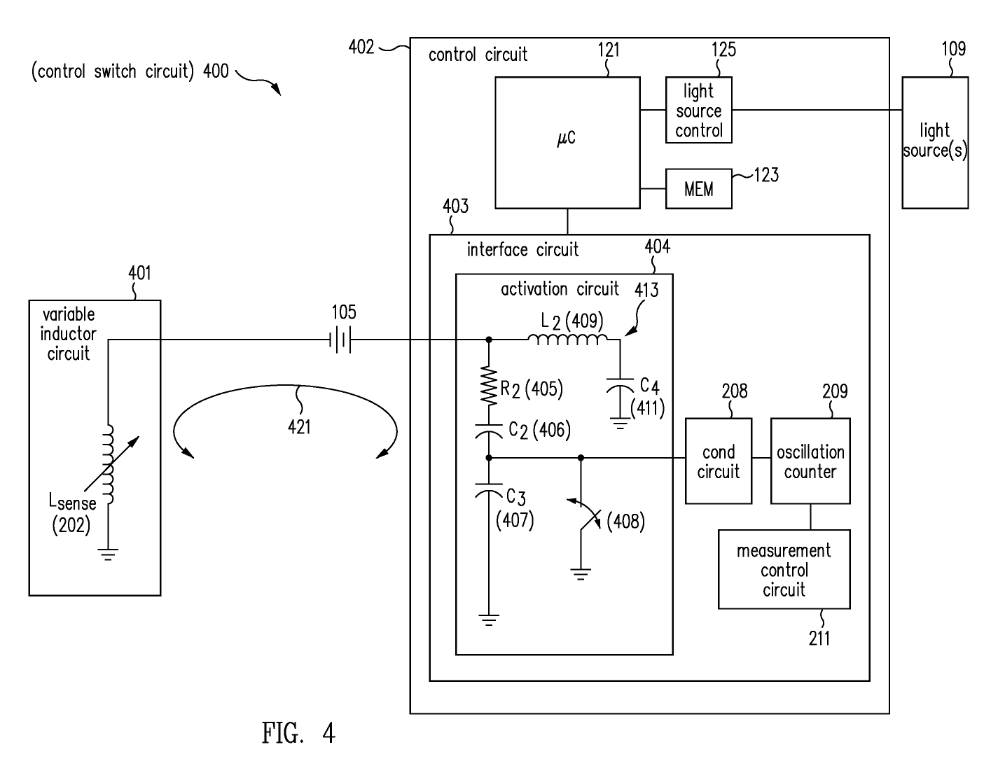

A variable inductor circuit (e.g., several embodiments of which are shown in and further described with regard to FIGS. 2 and 4) uses the variable inductance of the variable inductor to output an oscillating signal when the variable inductor circuit is activated by control circuit 107. In this regard, control circuit 107 may induce (e.g., activate) the oscillating signal in the variable inductor circuit by, for example, providing a pulse (e.g., a voltage pulse and/or a current pulse). Control circuit 107 may detect the oscillating signal to measure its characteristics, such as the frequency of the oscillating signal. In one embodiment, the frequency of the oscillating signal may vary as a function of the inductance of the variable inductor. Thus, as the user operates the variable control by pressing on tail cap 101 to change the inductance of the variable inductor, control circuit 107 may activate the variable inductor circuit, and the frequency of the oscillating signal may change in response to the change in inductance caused by the user's operation of tail cap 101. By measuring the frequency of the oscillating signal, control circuit 107 may determine the setting of the variable control. In one embodiment, the variable inductor circuit may be located on base plate 119. In one embodiment, one or more wires 129/131 may connect the variable inductor circuit with control circuit 107 to activate the variable inductor circuit and to measure the frequency of the oscillating signal. In another embodiment, wires 129/131 may not be provided. In this case, battery 105 may provide the connection between the variable inductor circuit and control circuit 107.

Control circuit 107 includes a processor 121, a memory 123, a light source control circuit 125, and an interface circuit 127. Processor 121 may be implemented by a microcontroller, a microprocessor, logic, a field programmable gate array (FPGA), or any other appropriate circuitry. Memory 123 may include non-volatile memories and/or volatile memories. Memory 123 may be used to store instructions for execution by processor 121 such as to activate the variable inductor circuit and to measure the frequency of the oscillating signal, and/or may be used to store saved parameters such as saved settings of the variable control. Such saved settings allow lighting device 100 to save the settings of the variable control in effect before power to lighting device 100 is turned off and to restore the settings when power to lighting device 100 is turned back on. Memory 123 may also include scratch memories used by processor 121 to store variable values when executing instructions.

Interface circuit 127 includes circuitry under control of processor 121 to interface with the variable inductor circuit. Interface circuit 127 may detect that the user has placed lighting device 100 in a control setting mode to change the setting of the variable control, such as when the user rotates or otherwise actuates tail cap 101, or any other appropriate mechanism or control of lighting device 100. In one embodiment, interface circuit 127 may generate a pulse to activate the variable inductor circuit and to measure the frequency of the oscillating signal. In another embodiment, processor 121 may generate a pulse to activate the variable inductor circuit and interface circuit 127 may measure the frequency of the oscillating signal. Processor 121 may use the measured frequency from interface circuit 127 to determine a setting of the variable control for controlling a function of lighting device 100. For example, processor 121 may determine the brightness control setting for light sources 109 from the measured frequency. Interface circuit 127 may also be used to selectively connect lighting device 100 to other devices. For example, in one embodiment, interface circuit 127 may include a Universal Serial Bus (USB) port to pass data between device 100 and one or more other connected devices such as external flash memories.

Light source control circuit 125 includes circuitry under control of processor 121 to control the brightness of light sources 109. For example, light source control circuit 125 receives the brightness control setting from the processor 121 (e.g., determined by processor 121 based on the user-selected position of the variable control caused by the user selectively depressing tail cap 101) to adjust the brightness of light sources 109. Light source control circuit 125 may adjust the brightness of light sources 109 using techniques such as pulse width modulation (PWM), by controlling the number of light sources receiving power, or through other appropriate techniques.

FIG. 2 illustrates a schematic of a variable control circuit 200 implemented by a variable inductor circuit 201 connected to a control circuit 206 through two conductive wires 129/131 in accordance with an embodiment of the disclosure. Variable control circuit 200 may be used with a physical control manipulated by a user such as tail cap 101 to allow the user to adjust the variable control. Control circuit 206 is one embodiment of control circuit 107 of FIG. 1. Control circuit 206 includes processor 121, light source control circuit 125 and memory 123 as discussed with regard to FIG. 1. Control circuit 206 also includes an interface circuit 207 that is an embodiment of interface circuit 127 of FIG. 1. In one embodiment, variable inductor circuit 201 is located on base plate 119 near tail cap 101 and includes a variable inductor 202 with variable inductance Lₛₑₙₛₑ connected in parallel with a capacitor 203 with capacitance C₁. Lₛₑₙₛₑ may vary as a user applies different levels of force on tail cap 101 to induce a changing magnetic field on variable inductor 202. Variable inductor circuit 201 also includes a resistor 205 with resistance R₁ connected in series with the variable inductor 202/capacitor 203 network. Resistor 205 connects to processor 121 through a first wire 129 running from variable inductor circuit 201 to control circuit 206. Processor 121 may activate oscillation of variable inductor circuit 201 by applying a pulse on first wire 129. A second wire 131 from capacitor 203 to interface circuit 207 is used by interface circuit 207 to sense the frequency of the oscillating signal (e.g., denoted in FIG. 2 by semi-circular arrows 221) from variable inductor circuit 201.

Interface circuit 207 includes a conditioning circuit 208 that connects with second wire 131. Conditioning circuit 208 may include amplification circuitry to amplify the oscillating signal (e.g., amplify the voltage and/or current), filters to filter out high frequency spurious signals, and/or waveform shaping circuitry to shape the oscillating signal. Interface circuit 207 also includes an oscillation counter 209 used to measure the frequency of the oscillating signal under control of a measurement control circuit 211. Frequency of the oscillating signal may be measured with various techniques, such as using conditioning circuit 208 to shape the oscillating signal into a clock signal for clocking oscillation counter 209. By counting the number of clocks in a measurement interval, oscillation counter 209 may be used to derive the frequency of the oscillating signal. Alternatively, the oscillating signal may be sampled and processed using Fast Fourier Transform (FFT) to measure its spectral content. The magnitude of a maximum frequency bin of the spectral content may be compared against a detection threshold to detect the main frequency of the oscillating signal.

To activate the oscillation circuit, control circuit 107 may detect when the user has placed lighting device 100 into a control setting mode to change the setting of the variable control, such as when the user rotates tail cap 101 actuates tail cap 101, or any other appropriate mechanism or control of lighting device 100. Processor 121 activates variable inductor circuit 201 by generating a pulse on first wire 129 through a port on processor 121, such as through a general purpose I/O (GPIO) port. Alternatively, first wire 129 may be connected to interface circuit 207, and processor 121 may cause interface circuit 207 to generate the pulse. The pulse charges capacitor 203 to build up a voltage with a time constant determined by C₁ and R₁. The duration of the pulse may be adjustable as a function of the time constant. At the termination of the pulse, the voltage on capacitor 203 discharges, causing variable inductor circuit 201 to oscillate with a frequency that is determined by Lₛₑₙₛₑ, C₁, and R_{I}. Because Lₛₑₙₛₑ varies as the user applies different amounts of force on tail cap 101 to adjust the variable control, the frequency of the oscillating signal may be measured to determine the setting of the variable control. This oscillating signal on capacitor 203 is sensed by interface circuit 207 through second wire 131.

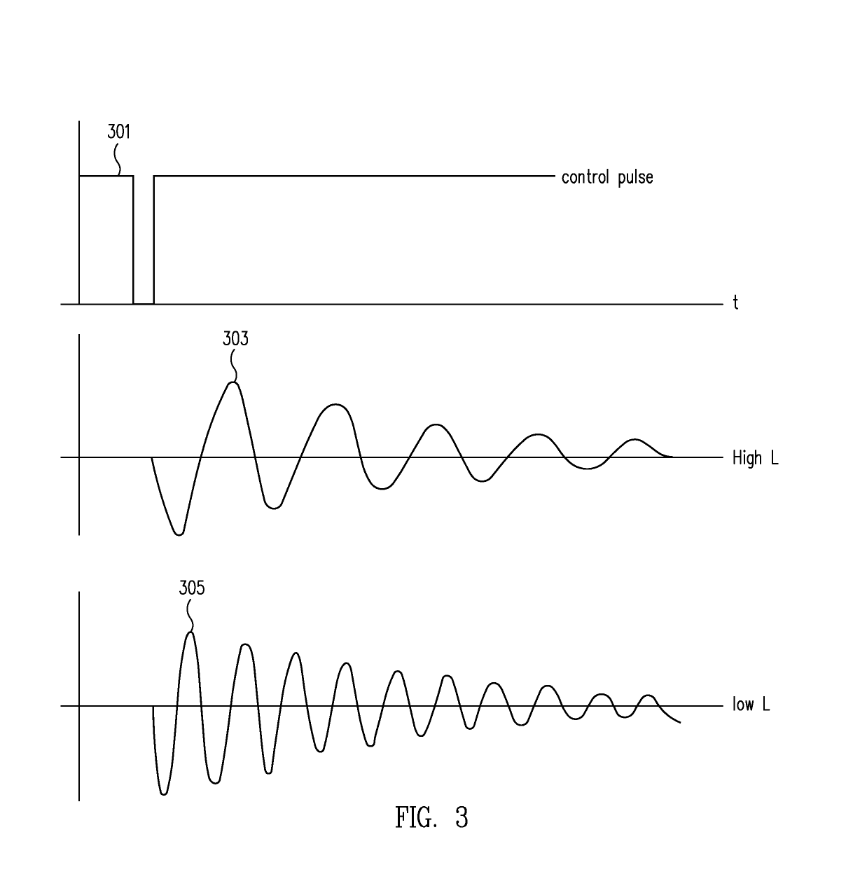

FIG. 3 illustrates several waveforms of oscillating signals of a variable inductor circuit generated in response to a pulse in accordance with an embodiment of the disclosure. Pulse 301 is applied to the variable inductor circuit as discussed. At the end of the pulse, the variable inductor circuit oscillates with a frequency determined by the inductance of the variable inductor. A higher inductance causes the oscillating signal to oscillate with a lower frequency as shown in waveform 303. On the other hand, a lower inductance causes the oscillating signal to oscillate with a higher frequency as shown in waveform 305. The amplitude of the oscillating signal decays over time. The rate at which the amplitude decays may also be a function of the inductance of the variable inductor.

The frequency of the oscillating signal may be measured. When the oscillating signal can no longer be detected due to the decaying amplitude, another pulse may be applied to the variable inductor circuit to generate a second oscillating signal and the measurement of the frequency may be repeated. In one embodiment, a train of pulses may be applied to the variable inductor circuit where the pulses are spaced by an interval greater than the time it takes for the oscillating signal to decay. In this manner, multiple frequency measurements may be taken for a measurement interval that is longer than the decay time of the oscillating signal.

In another embodiment, multiple frequency measurements may be taken of a single oscillating signal provided in response to a single pulse. For example, if the time it takes for an oscillating signal to decay is longer than a minimum measurement interval, the frequency of the single oscillating signal may change as the inductance of the variable inductor changes. Multiple frequency measurements of the single oscillating signal may be taken at multiple non-overlapping periods within the measurement interval to detect if the inductance changes during the measurement interval.

The multiple frequency measurements may be used to determine that a user has selected a setting of the variable control for a time interval. The multiple frequency measurements may also be compared with one another to ensure that they agree with one another within a range. In this manner, the multiple frequency measurements may be used to detect that the user has maintained the variable control in approximately the same position for at least the minimum measurement interval (e.g., a two-second hold in one embodiment) so that the new setting may be accepted. Thus, spurious or inadvertent settings of the variable control may be detected and rejected. Also, the user may thereafter release the variable control (e.g., tail cap 101 in one embodiment) while lighting device 100 retains the selected setting (e.g., in memory 123 in one embodiment).

Referring back to FIG. 2, conditioning circuit 208 may amplify, filter, and shape the oscillating signal to generate a counting clock for oscillation counter 209 to measure the frequency of the oscillating signal. Measurement control circuit 211 may reset oscillation counter 209 at the start of a frequency measurement. Oscillation counter 209 uses the counting clock to increment its count so as to count the number of cycles of the oscillating signal. Oscillation counter 209 may continue counting until the amplitude of the oscillating signal is too attenuated for conditioning circuit 208 to generate the counting clock. Measurement control circuit 211 may count the length of the frequency measurement as the interval during which counting clock is generated. At the end of the frequency measurement, the accumulated count in oscillation counter 209 may be stored into memory 123.

As discussed, a series of frequency measurements may be taken within a pre-determined measurement interval. In one embodiment, the measurement interval may be adjustable. To keep track of the measurement interval, measurement control circuit 211 may use a measurement interval counter to accumulate the length of the multiple frequency measurements. At the start of the measurement interval, measurement control circuit 211 may reset the measurement interval counter. Additionally, at the start of each frequency measurement within the measurement interval, measurement control circuit 211 may reset oscillation counter 209. At the end of the each frequency measurement, the count from oscillation counter 209 may be stored into memory 123. At the end of each frequency measurement, measurement control circuit 211 may also compare the count from oscillation counter 209 with previously stored counts of earlier frequency measurements to determine if the counts are all within an allowable range. If a count is not within the allowable range, measurement control circuit 211 may restart the measurement interval to obtain a new series of frequency measurements. Otherwise, if the counts are all within the allowable range, at the end of the measurement interval, a final count, such as an average of all the counts obtained during the measurement interval, and an average length of the multiple frequency measurements within the measurement interval may be presented to processor 121 to calculate a frequency of the oscillating signal. From the frequency calculation, processor 121 may determine the setting of the variable control and may adjust the brightness of light sources 109 through light source control circuit 125.

FIG. 4 illustrates a schematic of another variable control circuit 400 implemented by another variable inductor circuit 401 connected to another control circuit 402 through a battery 105 in accordance with an embodiment of the disclosure. In contrast to the embodiment of FIG. 2 that uses wires 129/131 to connect between control circuit 206 and variable inductor circuit 201, the embodiment of FIG. 4 uses battery 105 to connect between variable inductor circuit 401 and control circuit 402.

Variable inductor circuit 401 includes variable inductor 202 with variable inductance Lₛₑₙₛₑ and may be positioned in base plate 119 near tail cap 101. Control circuit 402 is one embodiment of control circuit 107 of FIG. 1. Control circuit 402 includes processor 121, light source control circuit 125, and memory 123 as discussed with regard to FIG. 1. Control circuit 402 also includes an interface circuit 403 that is an embodiment of interface circuit 127 of FIG. 1. Interface circuit 403 includes an activation circuit 404, conditioning circuit 208, oscillation counter 209, and measurement control circuit 211.

Activation circuit 404 is used to activate variable inductor circuit 401. Activation circuit 404 also provides capacitors that, together with variable inductor circuit 401, form the inductor/capacitor network that generates the oscillating signal (e.g., denoted in FIG. 4 by semi-circular arrows 421). Activation circuit 404 includes a capacitor 406 with capacitance C₂ that is connected in series with a capacitor 407 with capacitance C₃, and a resistor 405 with resistance R₂. The R2/C2/C₃ network is connected in parallel with variable inductor 202 through battery 105.

Because battery 105 is used to connect the oscillating signal from variable inductor 202 of variable inductor circuit 401 to activation circuit 404, an alternating current (AC) voltage of the oscillating signal is introduced on the direct current (DC) voltage of battery 105. Accordingly, a low pass filter circuit is connected to battery 105 to filter out the AC voltage of the oscillating signal from the DC voltage of battery 105 before the battery voltage is applied to the rest of lighting device 100. The low pass filter (LPF) includes an inductor 409 with inductance L₂ and a capacitor 411 with capacitance C₄. The L₂/C₄ LPF is connected in parallel with the R2/C2/C₃ network. A filtered voltage 413 taken from the node between L₂ and C₄ is used as the DC voltage to power control circuit 402 and light sources 109.

The node between capacitors 406 and 407 is connected to conditioning circuit 208 and a switch 408. Switch 408 is under control of processor 121 and is in the default closed position before the activation of variable inductor circuit 401. This shorts capacitor 407 to ground to allow voltage from battery 105 to charge capacitor 406. When control circuit 402 detects that a user has placed lighting device 100 into a control setting mode to change the setting of the variable control, processor 121 opens switch 408. The voltage on capacitor 406 discharges and causes variable inductor circuit 401 to oscillate with a frequency that is determined by Lₛₑₙₛₑ, C₂, C₃, and R₂. This activation of the oscillating signal is similar to the action of capacitor 203 discharging its voltage to cause the variable inductor circuit 201 of FIG. 2 to oscillate at the end of the pulse. Similarly, because Lₛₑₙₛₑ may vary as the user applies different amounts of force on tail cap 101 to control the variable control, the frequency of the oscillating signal may be measured to determine the setting of the variable control. This oscillating signal is sensed by conditioning circuit 208 through the node between capacitors 406 and 407. The oscillating signal may be illustrated by FIG. 3. Conditioning circuit 208, oscillation counter 209, and measurement control circuit 211 operate to count the number of cycles of the oscillating signal during the measurement interval. Operations of these modules are the same as discussed with regard to FIGS. 2 and 3.

At the end of a frequency measurement, if multiple frequency measurements are desired, processor 121 may close switch 408 again to allow battery voltage to charge capacitor 406. After waiting for capacitor 406 to reach the DC voltage of battery 105, processor may again open switch 408 to cause variable inductor circuit 401 to oscillate and to measure the frequency of the oscillating signal. Thus, multiple frequency measurements may be taken during a measurement interval to ascertain a setting of the variable control.

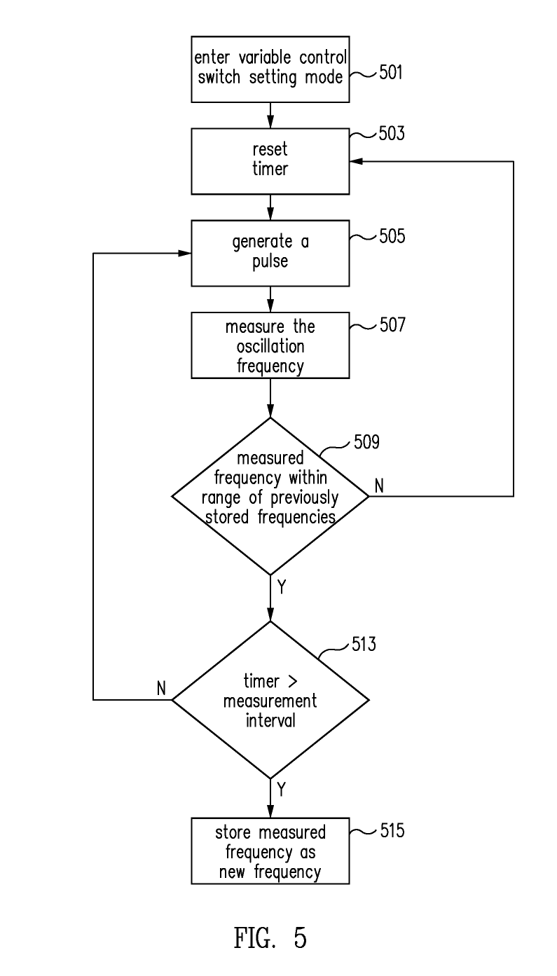

FIG. 5 illustrates a flow chart of steps for measuring a frequency of an oscillating signal to detect a switch setting of a variable control when a decaying time of the oscillating signal is less than a minimum measurement interval in accordance with an embodiment of the disclosure.

In step 501, a user enters a control setting mode to change the setting of the variable control. As discussed, such mode may be detected by a processor detecting that the user has actuated tail cap 101 or through another appropriate technique. The user may selectively depress tail cap 101 to select a position of the variable control to cause a change in the inductance of the variable inductor circuit (e.g., 201 of FIG. 2 or 401 or FIG. 4).

In step 503, a measurement interval counter of measurement control circuit 211 of FIG. 2 or FIG. 4 is reset to keep track of the measurement interval. Also in step 503, oscillation counter 209 is reset for measuring the frequency of the oscillating signal.

In step 505, the control circuit 206 or 402 generates a pulse to activate the oscillating signal. As discussed with regards to FIGS. 2 and 4, a voltage across a capacitor connected in parallel with the variable inductor circuit may be charged by a pulse. The voltage on the capacitor may then be discharged to generate the oscillating signal as an oscillating voltage. Alternatively the oscillating signal may be generated as an oscillating current. The frequency of the oscillating signal is a function of the inductance of the variable inductor circuit. Therefore, by measuring the frequency of the oscillating signal, the method may determine the setting of the variable control. In addition the rate at which the amplitude of the oscillating signal decays may also vary with the inductance of the variable inductor circuit. In an alternative embodiment, the rate of decay of the oscillating signal may be measured to determine the setting of the variable control.

In step 507, the measurement interval counter is started to measure the frequency of the oscillating signal. For example, the method may accumulate the number of cycles of the oscillating signal in oscillation counter 209 to measure the frequency. In one embodiment, the frequency of the oscillating signal may be measured for as long as the amplitude of the oscillating signal is detected. For example, as the amplitude of the oscillating signal decays over time, the method may perform the frequency measurement until the amplitude is too attenuated for detection. In another embodiment, the frequency measurement may be performed for a known interval where the interval may be adjustable to accommodate oscillating signals of different frequencies and decaying rates.

In step 509, when the frequency measurement is completed, the currently measured frequency is stored in memory 123. If this is not the first frequency measurement of the measurement interval, the currently measured frequency may be compared against previously measured frequency or frequencies of earlier measurement(s) stored in memory 123. For example, the current count of oscillation counter 209 may be stored and compared with previously stored counts. If the currently measured frequency does not fall within an allowable range of the previously measured frequency or frequencies, the step 503 may be performed again to restart the measurement interval by resetting the measurement interval counter. Thus, the allowable range used for the measurement comparison may be used to detect that the user has held the variable control in approximately the same position during the measurement interval. The allowable range may also be used to reject spurious measurements or inadvertent setting of the variable control. The allowable range may be adjustable to accommodate a desired sensitivity of the control setting of the variable control.

If the currently measured frequency falls with the allowable range of the previously measured frequency or frequencies then, in step 513, the measurement interval counter is compared against a minimum measurement interval to determine if additional frequency measurements are to be performed. If the minimum measurement interval has not been reached, step 505 is performed again to generate an additional pulse to activate an additional oscillating signals for an additional frequency measurement. Steps 505 through 513 are repeated until the measurement interval counter reaches the minimum measurement interval. The minimum measurement interval may be adjustable to accommodate measurements of different oscillating signals.

In another embodiment, if the decaying time of the oscillating signal is longer than the minimum measurement interval, multiple frequency measurements may be taken at multiple non-overlapping periods of a single oscillating signal. In this case, if the minimum measurement interval has not been reached, step 505 may not be repeated to activate another oscillating signal. Instead, step 507 may be repeated to take additional measurements of the same oscillating signal.

In step 515, if the measurement interval counter reaches the minimum measurement interval, the currently measured frequency may be output as the measured frequency in step 515. Alternatively, an average of the currently measured frequency and all the previously measured frequencies taken during the measurement interval may be output as the measured frequency. For example, an average of the current count of oscillation counter 209 and all the previously stored counts may be used. Alternatively, a sum of all the counts taken during the measurement interval along with the measurement interval counter may be provided to processor 121 for processor 121 to determine the frequency of the oscillating signal. Thus, by making multiple frequency measurements for a minimum measurement interval and by comparing the multiple frequency measurements, the method may accept a setting of the variable control only when the user has held the variable control in approximately the same position for at least the minimum measurement interval.

In addition to and/or alternatively to the various embodiments previously described herein, a lighting device may be implemented with a variable inductor that may be adjusted by a user. The variable inductor may be placed in (e.g., completely in or substantially in) a tail cap of the lighting device and in series with a battery of the lighting device. In some embodiments, the user may rotate a control disposed at the tail cap of the lighting device which causes a ferrous component to rotate relative to a magnetic coil. The magnetic coil may be implemented, for example, with a wire coil wound around another ferrous component (e.g., a ferrous core). The ferrous component may be configured in a non-uniform manner such that gaps between the ferrous component and the magnetic coil vary as the ferrous component is rotated about the wire coil/core. The variable inductor may also be selectively shorted by another user control, such as a push button switch, for example, also positioned in the tail cap. Other implementations of the rotatable ferrous component, magnetic coil, and/or the switch may be used in various embodiments.

A signal (e.g., current and/or voltage) may be periodically induced through the magnetic coil (e.g., by periodically charging and/or discharging a capacitor) and associated signals may be measured which vary depending on the inductance exhibited by the variable inductor (e.g., an inductance adjusted by rotation of the user control and/or a shorting of the inductor by engagement of the push button switch). Such signals may be used to control operation of the lighting device (e.g., on/off, variable brightness, maximum brightness, and/or other features).

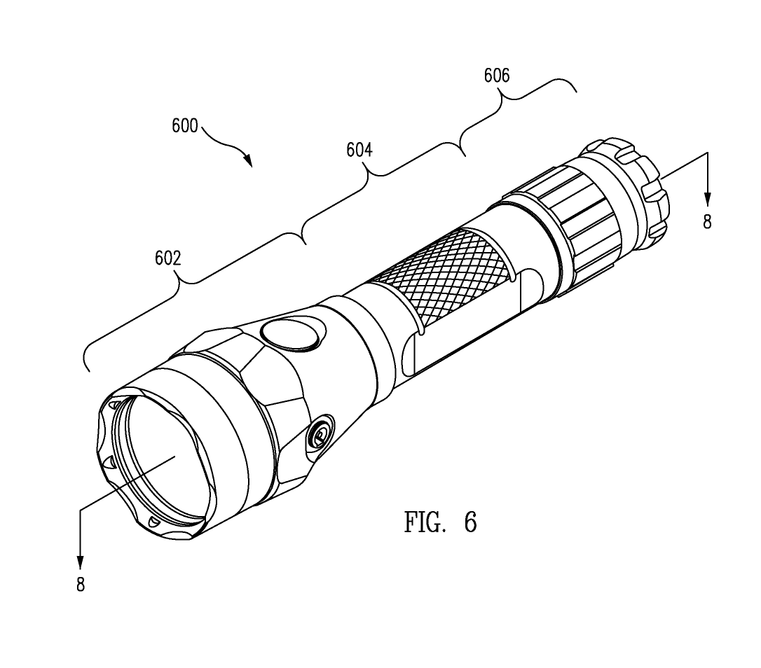

FIG. 6 is an upper, front and left side perspective view of an example lighting device 600 (e.g., a flashlight), within which variable inductor control methods and associated apparatus of the present disclosure can be used advantageously. FIG. 7 is an exploded front and left side perspective view of the example lighting device 600. As can be seen in these figures, for conceptualization purposes, the device 600, can be thought of as comprising three main elongated portions coupled together longitudinally, namely, a lens and light source “head” portion 602, an intermediate battery housing portion 604, and a tail cap assembly portion 606, which includes features discussed below that are operable by a user of the device 600 to control its light output, including a switch 640 used to provide a switched control signal (e.g., for on/off, maximum brightness, and/or other operations), and a rotatable user control 644 (e.g., a knob or ring) which, when turned circumferentially, may be used to provide a substantially continuous control signal (e.g., a variable control signal that may vary in a continuous manner and/or with fine-grained small steps to increase or decrease the intensity of the light output by the device 600 and/or perform other operations) as further discussed herein.

As can be seen in FIG. 7, the head portion 602 can include an annular bezel 608 that couples to a lens-and-light source housing 610 so as to seal and retain within the housing 610 several rings 609 and 613, as well as a plurality of elements, such as a planar lens 612, a reflector device 614, which in one embodiment, can comprise a total internal reflection (TIR) lens, and a circular printed circuit board (PCB) 616 upon which one or more light sources 618 (e.g., light emitting diodes (LEDs) and/or other appropriate light sources) and other circuitry can be mounted. Power and control boards 620 can interface with a front end battery coupler and front battery spring contact 622, and serve to convey power and control signals from the battery 626 into the rear end of the head housing 610, and thence, to the light source(s) 618 and/or other circuitry on the light source PCB 616. The head portion 602 can also include a user control switch 623 configured to, for example, select from a plurality of the light sources 618 one which emits light at a desired wavelength, e.g., infrared (IR) or white or amber-colored visible light. Additionally, the head portion 602 can include a port 625 to which a charger for the battery 626 can be plugged, and/or through which control and/or test signals can be coupled from or into the lighting device 600, respectively (e.g., for programming and/or configuring lighting device 600).

As illustrated in FIG. 7, the intermediate battery housing portion 604 of the lighting device 600 can comprise rings 627/629, and an elongated, electrically conductive, e.g., metal, tubular housing 624 within which one or more batteries 626 (e.g., one or more individual cells coupled in series), for powering the light source(s) 618, is housed. In some embodiments, battery 626 can comprise one or more commonly available, standard-sized rechargeable batteries, such nickel cadmium (NiCd), nickel metal hydride (NiMH), lithium ion (Li-ion), or lithium ion polymer (Li-ion polymer) batteries, which can be recharged via an adapter that plugs into the port 625 of the head portion 602.

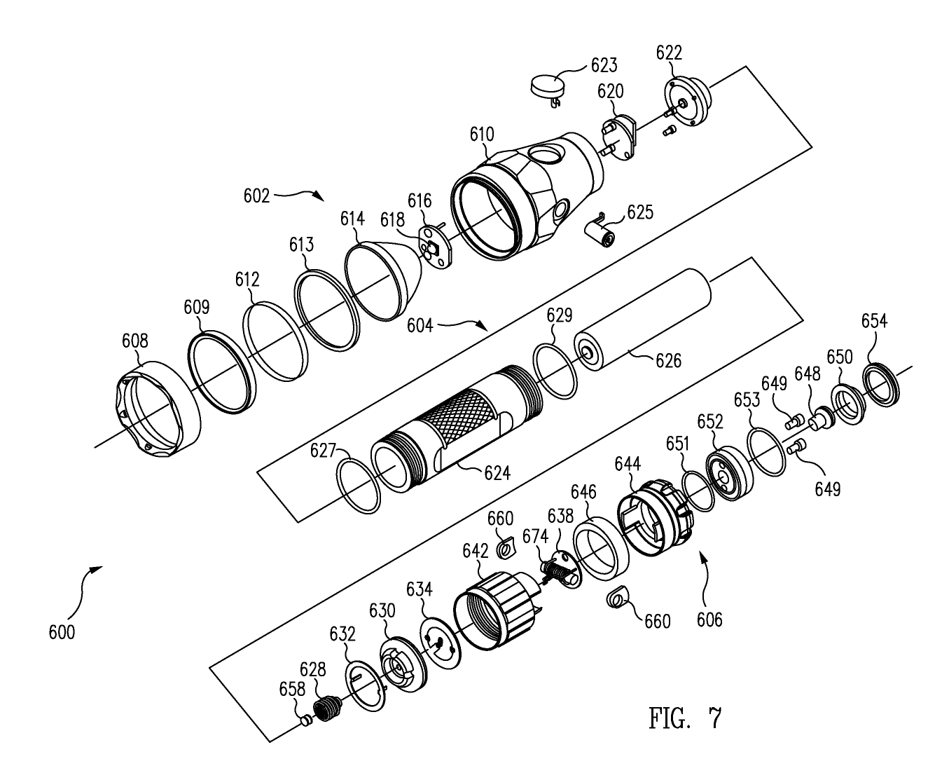

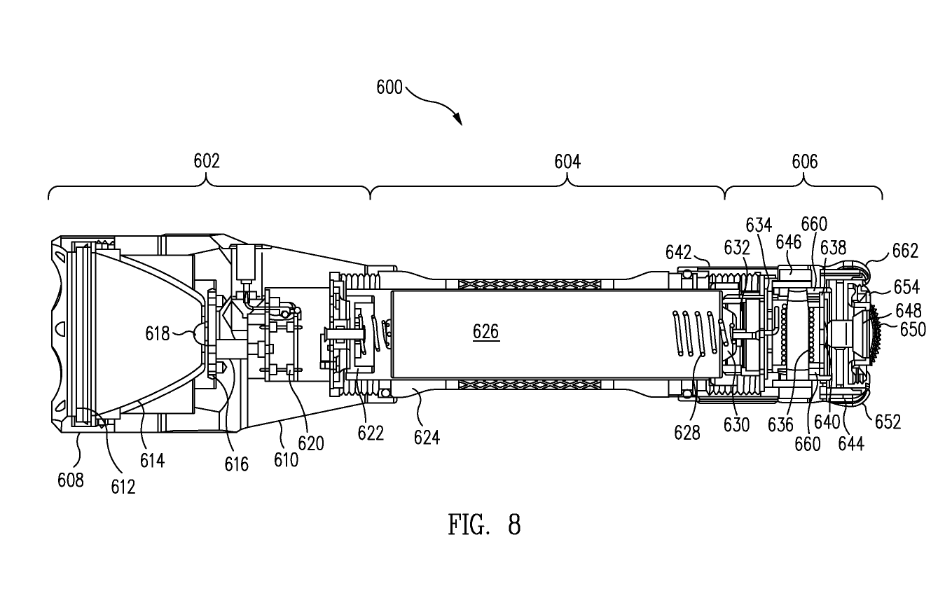

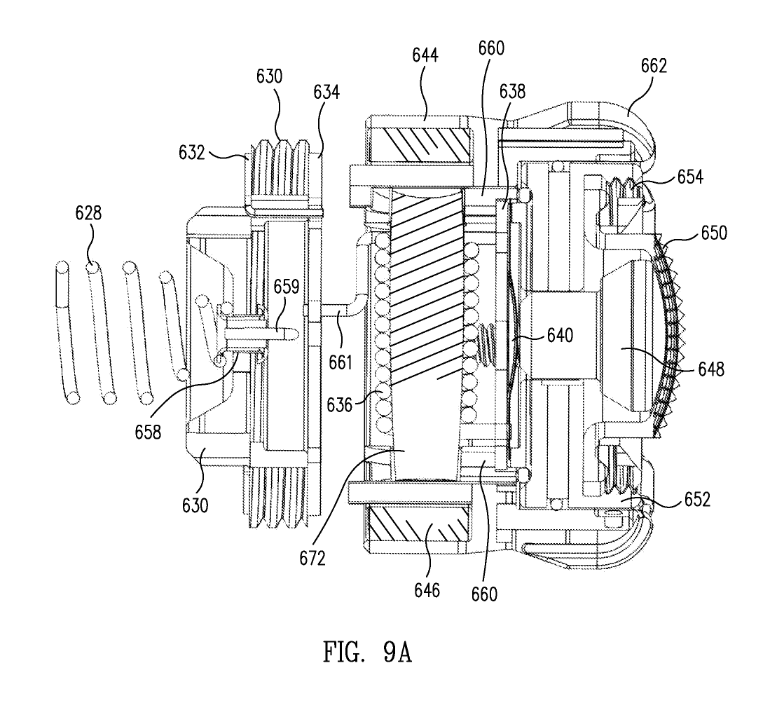

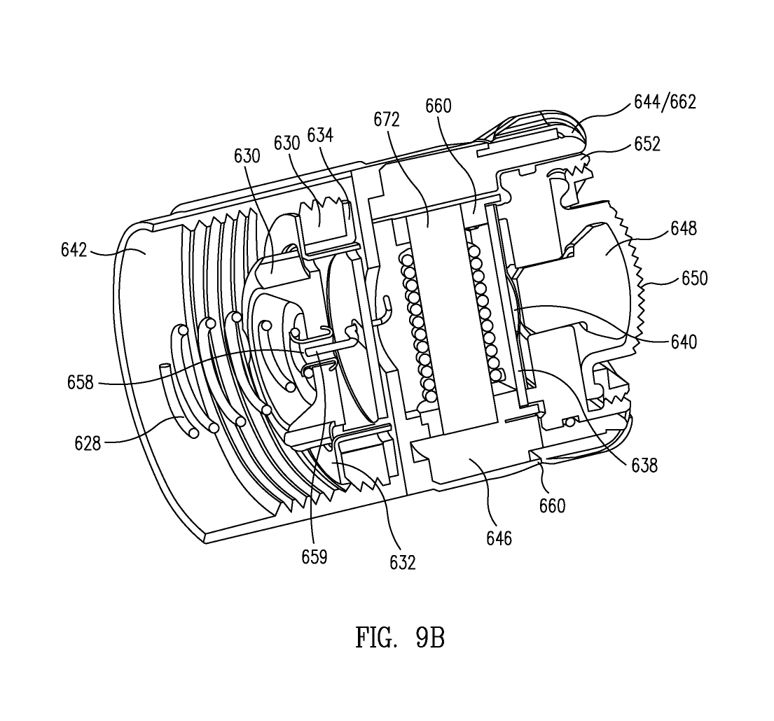

As described in more detail below, the tail cap assembly portion 606 of the lighting device 600 in FIG. 7 comprises two user control features of the device 600, including a pushbutton, on-off momentary contact “dome” switch 640 disposed at the rear end of the device 600 (e.g., mounted on a rear side of PCB 638 and further illustrated in FIGS. 8, 9A-B, and 10A-B), and a rotatable user control 644 (e.g., disposed slightly forward of and forming part of the distal end in some embodiments), which is used to vary the inductance of a variable inductor 679 (see FIGS. 11A-B).

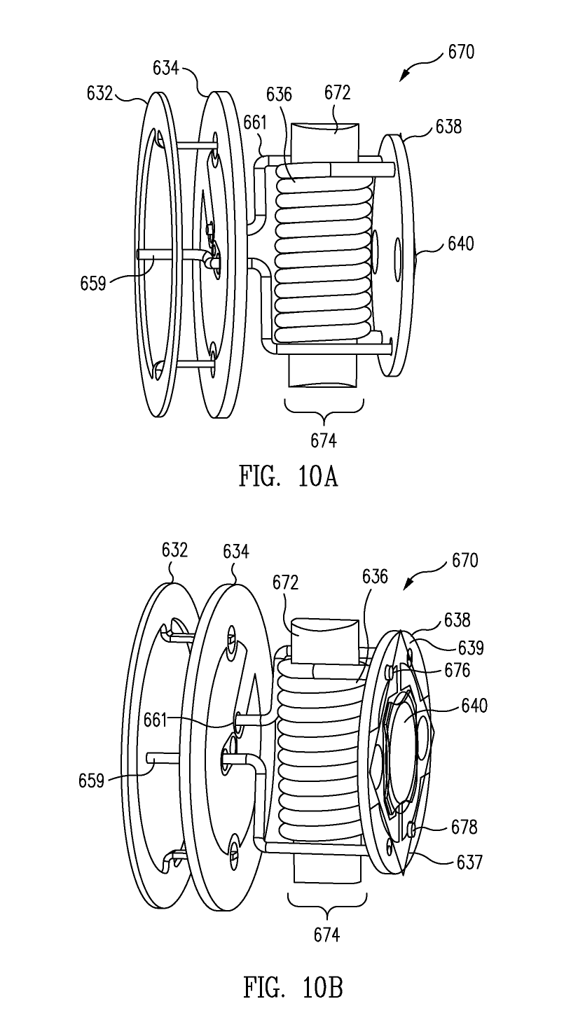

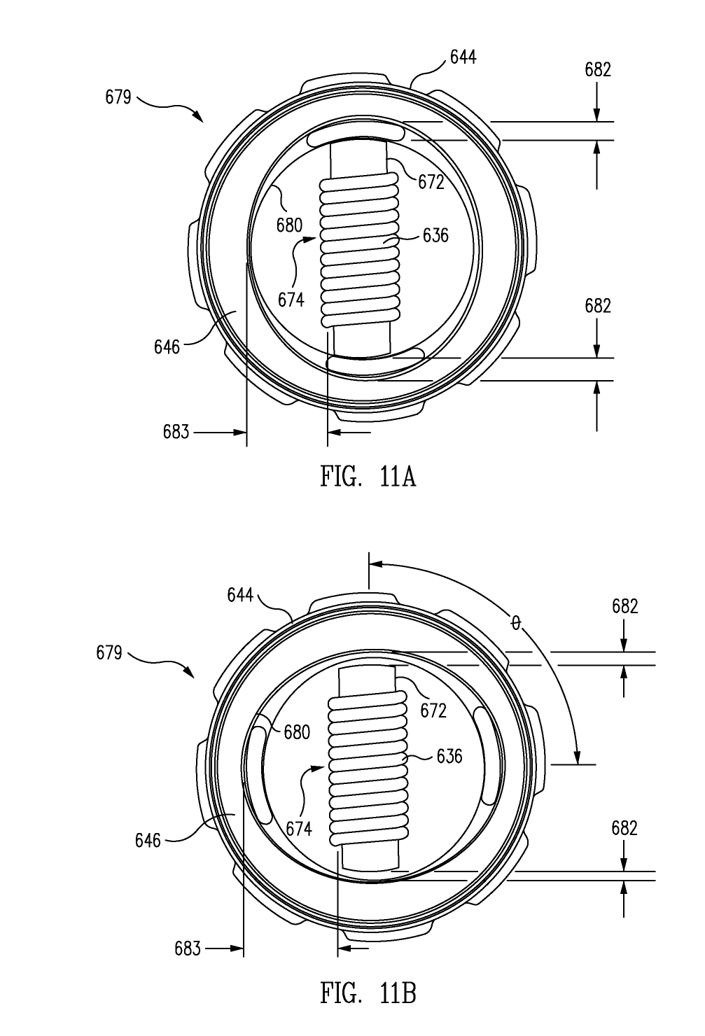

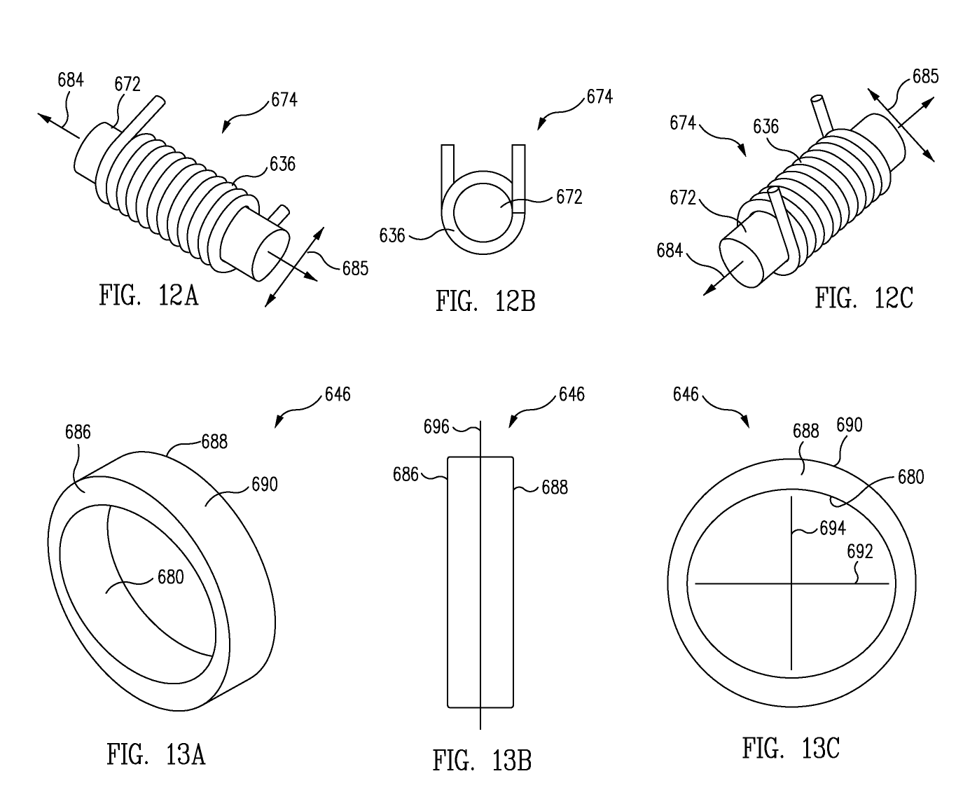

As can be seen in, e.g., FIG. 7, the tail cap assembly portion 606 of the device 600 comprises a rear battery contact spring 628 and spring holder 630 for making contact with a negative terminal of the battery 626, and a contact washer 632 that serves to connect a terminal of the variable inductor 679 to the conductive housing 624 of the device 600. The contact washer 632, together with a contact PCB 634, wires (e.g., conductors) 659 and 661 (see FIGS. 10A-10B), a coil 636 and a core 672 (e.g., collectively providing a magnetic coil 674, see FIGS. 12A-C), a switch PCB 638, and a momentary contact switch 640 (e.g., disposed on a rear surface of the switch board 638 and not shown in FIG. 7), comprise a tail cap wiring assembly 670 of the example lighting device 600, as illustrated in more detail in FIGS. 10A-B.

The tail cap wiring assembly 670 of the device 600, along with the momentary contact switch 640 and its associated mechanical components, is disposed in a two-part ferrule located at the rear end of the device 600. A first part of the ferrule is a fixed part 642 that couples, e.g., by way complementary threads, to a rear end of the tubular battery housing 624, and within which the tail cap wiring assembly 670 is fixedly housed. A second part of the ferrule is rotatable user control 644 disposed at the rear end of the device 600 that is rotatably coupled to the fixed part 642, and within which a ferrous structure 646 (e.g., a ring in some embodiments, and other shapes may be used in other embodiments) and components associated with the momentary contact switch 640, including a switch plunger 648, an elastomeric domed plunger cover 650, an end plug 652 (e.g., attached to fixed part 642 by screws 649), rings 651/653, and switch assembly retaining ring 654, are housed. The domed plunger cover 650 supplies an axial resiliency to the switch plunger 648 that causes it to return to its original position after having been momentarily depressed by a user.

FIG. 8 is a cross-sectional view of the example lighting device 600, as seen along the lines of the section 8-8 taken in FIG. 6, showing the relative position of the components of the device 600 assembled. FIG. 9A is an enlarged view of the cross-section shown FIG. 8 in accordance with an embodiment of the disclosure. FIG. 9B is an enlarged perspective view of the cross-section shown in FIG. 8 in accordance with an embodiment of the disclosure. In FIG. 9A, the fixed part 642 of the two-part ferrule of the tail cap assembly portion 602 has been omitted to show spring holder 630 which also serves as a threaded spacer disposed between the contact ring 632 and the contact board 634. Also shown is a swaged conductive via 658 used to couple the rear battery spring 628 to the contact board 634 and a wire 659 extending rearwardly through the tail cap assembly portion 602 and to the switch board 638. Also seen in FIGS. 9A and 9B are a pair of holders 660 having respective openings through which respective ones of the opposite ends of core 672 are disposed, as well as an optional covering 662 (e.g., for finger comfort) that can be molded over the distal end of the rotatable part 644 of the ferrule to rotate therewith.

FIGS. 10A and 10B are a front and left side perspective view, and a rear and left side perspective view, respectively, of the tail cap wiring assembly 670 of the tail cap assembly portion 602 of the lighting device 600. As discussed, the tail cap wiring assembly 670 comprises contact washer 632, PCB 634, wires 659 and 661, magnetic coil 674 (including coil 636 and core 672), switch PCB 638, and switch 640. In some embodiments, core 672 may be made of a magnetically permeable material (e.g., powdered iron or other ferrous material). Core 672 is illustrated as being substantially cylindrical, however, other shapes may be used as appropriate. Coil 636 is electrically conductive and wraps about core. The coil 636 can comprise, for example, a copper wire. As further illustrated in FIGS. 10A and 10B, the opposite ends 676 and 678 of the coil 636 can be respectively coupled to corresponding conductive traces 639 and 637, respectively, on the rear surface of the switch board 638, and respective electrical potentials can be applied to these traces by wire 659 (e.g., connected to a negative terminal of battery 626 through via 658 and spring 628) and wire 661 (e.g., connected to housing 624 through PCB 634 and contact washer 632) which are coupled to traces 637 and 639, respectively.

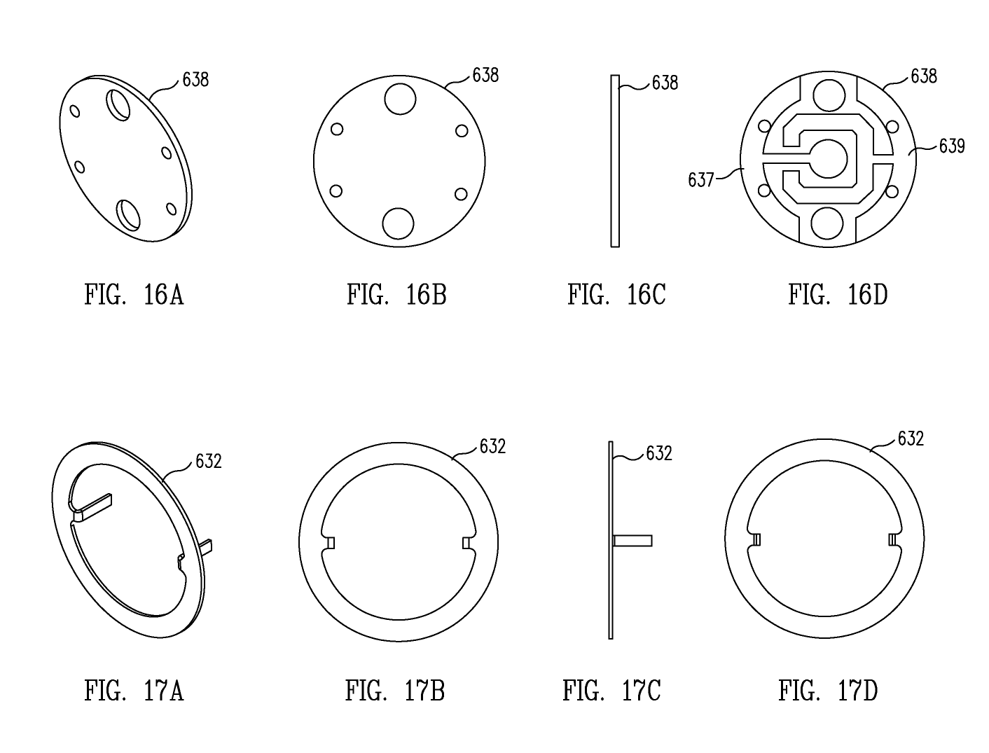

FIG. 16D further illustrates the traces 637 and 639 of PCB 638. A user depression of switch 640 connects traces 637 and 639 of PCB 638, thus shorting wires 659 and 661 together which bypasses (e.g., shorts) variable inductor 679, as further described herein.

FIG. 11A is a front end elevation view of the rotatable user control 644 and the variable inductor 679 which includes ring 646 and a magnetic coil 674 (e.g., including coil 636 and core 672). FIG. 11B is a front end elevation view of the rotatable user control 644 and the variable inductor, showing ring 646 rotated clockwise through an angle θ of about 90 degrees relative to its position shown in FIG. 11A, as can be effected by rotating user control 644 relative to fixed part 642. In this regard, ring 646 is fixed within user control 644 and thus rotates with user control 644 in response to user actuation thereof.

Although coil 636 will exhibit some minimal inductance by itself, that inductance will be appreciably increased by the incorporation of core 672 extending axially through the coil 636. Thus, if a current is passed through the coil 636, a magnetic field will be induced in the core 672 that flows between the ends of the core 672.

The magnetic field, and hence, the inductance of the variable inductor 679, can be further enhanced by the provision of ring 646 (e.g., made of ferrous material as described). Further, the enhanced inductance, which serves as a proxy for a control signal used to control the lighting device 600, can be made continuously variable between minimum and maximum values by configuring the inner circumfery 680 of the ring 646 in the form of an ellipse (e.g., having orthogonal major and minor axes) and/or other shapes.

When the long (e.g., major) axis 692 (see FIG. 13C) of the elliptical inner circumfery 680 of the ring 646 is oriented substantially parallel to the long axis 684 (see FIGS. 12A and 12C) of the core 672 (e.g., substantially perpendicular to the short axis 685 of the core 672) as shown in FIG. 11A, the distance 682 (e.g., gap) between respective ones of opposite ends of core 672/ends of coil 636 and the inner circumfery 680 of the ring 646 (thin portion) will be maximized, and a relatively thin portion of the ring 646 is disposed above and below core 672. Also, the distance 683 (e.g., gap) between longitudinal sides of core 672/windings of coil 636 and the inner circumfery 680 of the ring 646 (thick portion) will be minimized.

By rotating the ring 646 such that the short (e.g., minor) axis 694 (see FIG. 13C) of the elliptical inner circumfery 680 of the ring 646 is oriented substantially parallel to the long axis 684 of the core 672 (e.g., substantially perpendicular to the short axis 685 of the core 672) as shown in FIG. 11B, the gaps 682 will be minimized, and a relatively thick portion of the ring 646 is disposed above and below core 672. Also, the distance 683 between longitudinal sides of core 672/windings of coil 636 and the inner circumfery 680 of the ring 646 (thin portion) will be maximized. The change in gaps 682 affects the magnetic fields associated with current flowing through coil 636. As a result, the inductance exhibited by inductor 679 can vary continuously as ring 646 is rotated relative to core 672 and coil 636.

The effective inductance of the variable inductor 679 may be used as a proxy for one or more control signals to control the operation of device 600. For example, a user may continuously select between minimum and maximum control signal values by rotating user control 644 which causes ring 646 to rotate relative to core 672 and coil 636. In addition, the user may selectively bypass the variable inductor 679 by operating switch 640.

FIG. 12A is a bottom and left side perspective view of a magnetic coil 674, which includes coil 636 and core 672. FIG. 12B is an end view thereof, and FIG. 12C is a top and left side perspective view thereof. As can be seen in these figures, the core 672 of the magnetic coil 674 includes a long axis 684 and a short axis 685, each of which can be disposed coaxial with either a major axis 692 or a minor axis 694 of the elliptical inner circumfery 680 of ring 646, as discussed with regard to FIGS. 11A and 11B, respectively.

FIG. 13A is a front and left side perspective view of the ring 646, FIG. 13B is a side elevation view thereof, and FIG. 13C is a rear end elevation view thereof. As can be seen in these figures, the ring 646 comprises substantially parallel and generally planar front and rear surfaces 686 and 688, a substantially cylindrical outer circumfery 690, and a substantially elliptical inner circumfery 680 having a major axis 692 and a minor axis 694.

As illustrated in FIG. 13B, a central plane 696 of the ring 646 is disposed between and parallel to the front and rear ends 686 and 688 and passes through a center of the ring 646. As discussed above and illustrated in FIGS. 11A and 11B, when assembled, the magnetic coil 674 is disposed within the elliptical inner circumfery 680 of the ring 646 such that the axis 684 of the core 672 is disposed generally coplanar with the central plane 696 of the ring 646, and the ring 646 is continuously rotatable relative to the magnetic coil 674 between a first position in which the axis 684 of the core 672 is disposed coaxially with the major axis 692 of the elliptical inner circumfery 680 of the ring 646, and a second position in which the axis 684 of the core 672 is disposed coaxially with the minor axis 694 of the elliptical inner circumfery 680 of the ring 646.

Although a 90 degree clockwise rotation has been described, other directions (e.g., bidirectional clockwise and counterclockwise rotations) and other rotation angles (e.g., 45 degrees, 180 degrees, 270 degrees, 360 degrees, and/or other intermediate rotation angles) are contemplated. In various embodiments, ring 646 may be configured with other inner circumfery 680 shapes (e.g., non-elliptical) and/or other outer circumfery 690 shapes (e.g., non-circular and/or non-cylindrical ferrous structures shaped differently than ring 646) to adjust the inductance of variable inductor 679 as desired.

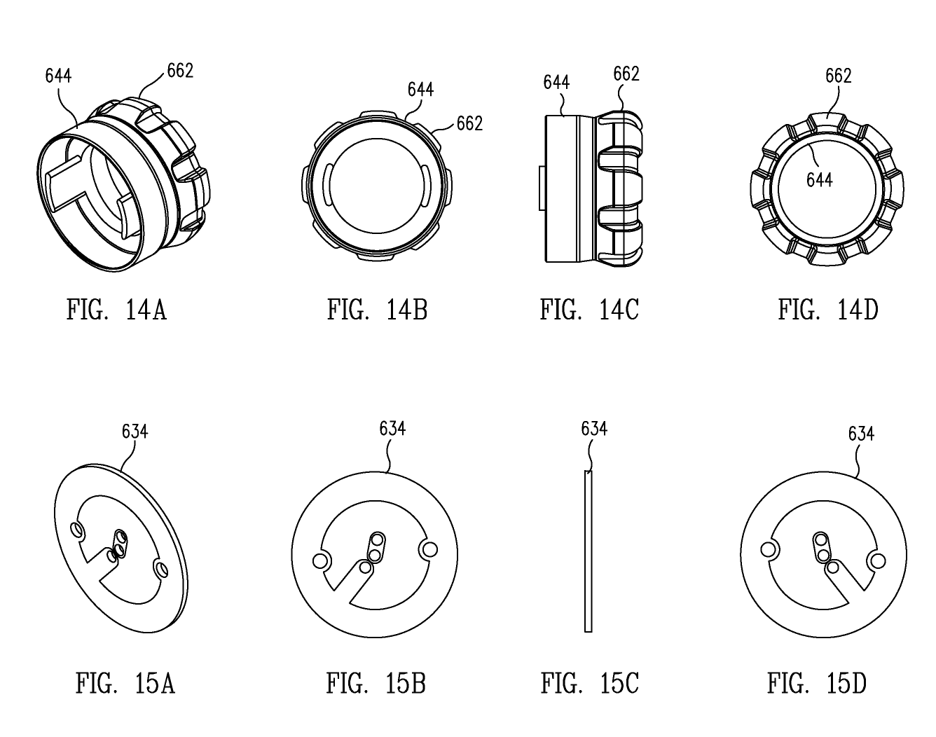

FIG. 14A is a front and left side perspective view of the rotatable user control 644 within which the ring 646 is fixed for conjoint circumferential rotation, and the covering 662 molded thereon. FIG. 14B is a front end view of the rotatable user control 644, FIG. 14C is a left side elevation view thereof, and FIG. 14D is a rear end view thereof.

FIG. 15A is a front and left side perspective view of the contact board 634 of the tail cap wiring assembly 670 of FIGS. 10A and 10B. FIG. 15B is a front end view of the contact board 634, and FIGS. 15C and 15D are enlarged left side elevation and rear end views of the contact board 634, respectively.

FIG. 16A is a front and left side perspective view of the switch board 638 of the example tail cap wiring assembly 670 of FIGS. 10A and 10B. FIG. 16B is a front end view of the switch board 634, and FIGS. 16C and 16D are enlarged left side elevation and rear end views of the switch board 634, respectively.

FIG. 17A is a front and left side perspective view of the contact washer 632 of the example tail cap wiring assembly 670 of FIGS. 10A and 10B. FIG. 17B is a front end view of the contact washer 632, and FIGS. 17C and 17D are enlarged left side elevation rear end views of the contact washer 632, respectively.

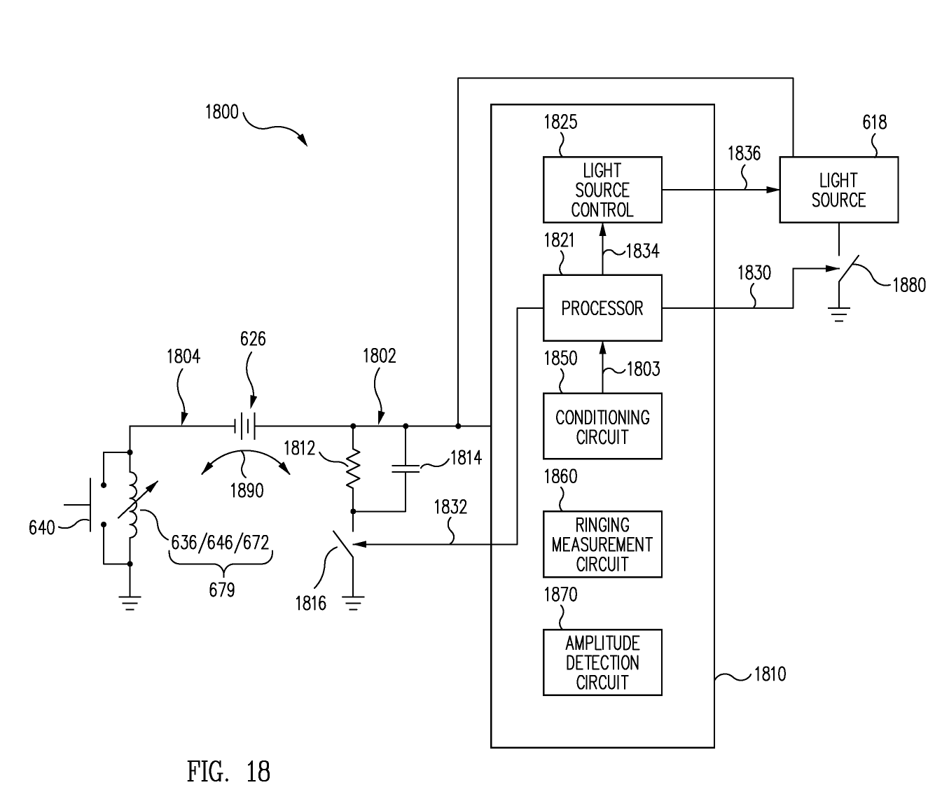

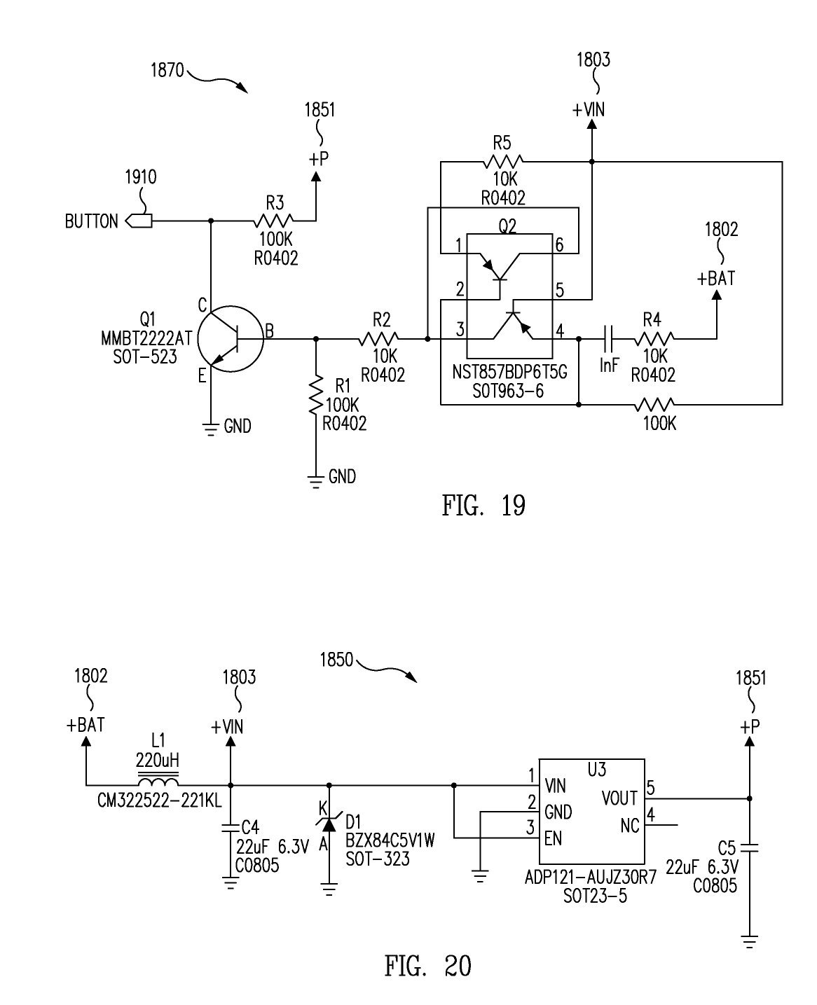

Referring now to FIG. 18, a block diagram 1800 is provided of various circuitry of lighting device 600 in accordance with an embodiment of the disclosure. Although several connections are shown between various components of block diagram 1800, various connections are omitted where appropriate for purposes of clarity. Additional connections are identified in the schematic diagrams of FIGS. 19-21.

As shown, the variable inductor 679 (e.g., provided by coil 636, ring 646, and core 672) is connected to a negative terminal of battery 626 at a node 1804 (e.g., through switch board 638, wire 659, via 658, and spring 628). The variable inductor 679 is also connected to ground (e.g., to housing 624 through switch board 638, wire 661, PCB 634, and contact washer 632). As discussed, dome switch 640 may be used to selectively bypass the inductor (e.g., by connecting traces 637 and 639 of switch board 638.

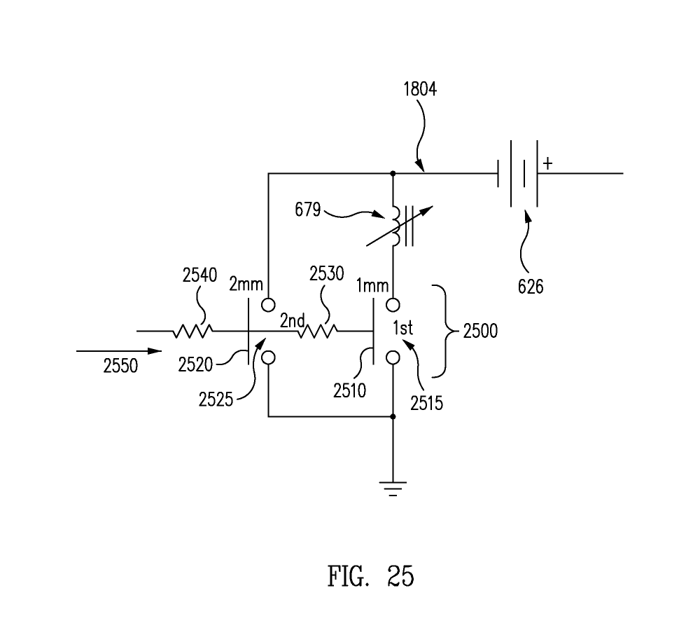

Other embodiments of the tail cap circuitry are also contemplated. For example, FIG. 25 illustrates another implementation of the tail cap circuitry with a multi-position switch 2500 in place of switch 640. As shown, switch 2500 may have switch contacts 2510 and 2520 that are positioned at different distances (e.g., approximately 1 mm and approximately 2 mm, respectively) from circuit contacts 2515 (in series with variable inductor 679) and 2525 (in parallel with variable inductor 679), respectively. Switch 2500 is also loaded by springs 2530 and 2540. Switch 2500 may be selectively operated by a user to selectively connect and bypass variable inductor 679.

For example, at a rest state (e.g., while switch 2500 is not depressed by the user), springs 2530 and 2540 may bias switch contacts 2510 and 2520 away from circuit contacts 2515 and 2525, such that circuit contacts 2515 and 2525 remain open. In this state, battery 626 is effectively disconnected from ground. As a result, lighting device 600 may be substantially or completely turned off.

As switch 2500 is initially depressed by the user, switch contact 2510 closes circuit contacts 2515, thus connecting the variable inductor 679 in series with battery 626. Also in this state, circuit contacts 2525 remain open (e.g., biased by spring 2540). In this state, substantially continuous user control signals may be generated (e.g., by adjusting the inductance of variable inductor 679 as discussed). In some embodiments, switch 2500 may be mechanically configured to physically lock in this state (e.g., switch contact 2510 may remain connected to circuit contacts 2515 when the user releases switch 2500 and may unlock, for example, in response to another user depression of switch 2500).

As switch 2500 is further depressed by the user, switch contact 2520 closes circuit contacts 2525, thus bypassing the variable inductor 679 in the manner discussed with regard to switch 640. In this state, switched user control signals may be generated in the manner discussed.

Thus, switch 2500 may be used to provide flexible operation of lighting device 600, while still providing the benefits of variable inductor 679 and switch 640. For example, in some embodiments, light source 618 may be switched to operate at a maximum brightness setting while switch 2500 is fully depressed (e.g., while switch contact 2520 closes circuit contacts 2525), operate at a variable brightness set by the variable inductor 679 while switch 2500 is partially depressed (e.g., while circuit contacts 2520 remain open and circuit contacts 2510 are closed), and cause lighting device 600 to turn substantially or completely off when switch 2500 is released (e.g., while circuit contacts 2510 and 2520 are open).

Referring again to FIG. 18, the positive terminal of battery 626 is connected to a node 1802. Also connected to node 1802 are a control circuit 1810, a resistor 1812, a capacitor 1814, and light source 618. In some embodiments, control circuit 1810, resistor 1812, capacitor 1814, switches 1816 and 1880 (further described herein), and various signal paths for associated control signals (further described herein) may be implemented by various components of head portion 602 of lighting device 600 (e.g., PCB 616, PCBs 620, and/or other components). In some embodiments, resistor 1812 may be implemented with a resistance that is large relative to the capacitive impedance of capacitor 1814 at resonant frequencies of variable inductor 679 and capacitor 1814.

Control circuit 1810 includes various components to detect user operations and control light source 618 in response thereto. As shown, control circuit 1810 includes a processor 1821, a light source control circuit 1825, a conditioning circuit 1850, a ringing measurement circuit 1860, and an amplitude detection circuit 1870.

Processor 1821 may be implemented in accordance with the various processor embodiments described herein. Processor 1821 may also be provided with memory, for example, in the manner of memory 123 of FIG. 4. As further described herein, processor 1821 receives various signals from other components of control circuit 1810 and may provide control signals 1830, 1832, and 1834, and/or other control signals as appropriate.

Control signal 1830 (e.g., based on a switched user control signal determined based on the operation of switch 640) selectively turns light source 618 on and off by operating a switch 1880 (e.g., a MOSFET transistor in some embodiments). In some embodiments, control signal 1830 may open switch 1880 (e.g., to turn off light source 618) during measurement periods further described herein (e.g., when switch 1816 is closed).

Control signal 1832 periodically connects capacitor 1814 to ground by operating a switch 1816 (e.g., a MOSFET transistor in some embodiments). In this regard, when capacitor 1814 is connected to ground through switch 1816, an oscillating (e.g., ringing or resonating) signal 1890 (e.g., current and/or voltage) will be induced as the voltage of node 1802 is pulled down while capacitor 1814 charges (e.g., switch 1816 and capacitor 1814 provide an activation circuit to trigger the oscillating signal). The frequency of such oscillation is determined by the inductance of variable inductor 679, a small wiring parasitic inductance around the circuit loop associated with oscillating signal 1890, the capacitance of capacitor 1814, and a small parasitic capacitance present in the other electronic and mechanical parts. Accordingly, the frequency of such oscillations depends primarily on the variable inductor 679 and the capacitor 1814, which is given by the following relationship:

$$frequency = \frac{1}{2 π \sqrt{LC}}$$

Thus, the frequency can vary, depending on the inductance exhibited by variable inductor 679 (e.g., dependent on the position of rotatable user control 644 and the engagement or disengagement of switch 640).

As further described herein, control circuit 1810 may perform periodic measurements. During each measurement period, switch 1880 is opened to prevent the light source 618 from loading the resonant circuit. Also during each measurement period, switch 1816 is closed to introduce oscillating signal 1890 on node 1802 (e.g., caused by a resonant current in the circuit loop). At the end of each measurement period, switch 1880 is closed and switch 1816 is opened. Various signals associated with the oscillations may be measured at the end of each measurement period, user control signals can be determined from such measurements, and light source 618 may be operated (e.g., by processor 1821 and/or light source control circuit 1825) in response to such determined user control signals.

Such measurement periods (e.g., the time elapsing while control signal 1802 operates to close switch 1816) may be relatively brief (e.g., on the order of several to 100 microseconds). The measurement periods may be repeated, but at intervals significantly longer than the measurement periods themselves (e.g., repeated approximately every several milliseconds while lighting device 600 is in an operating state, and longer such as approximately every 60-100 milliseconds while lighting device 600 is in a non-operating state). Because the measurement periods last for only microseconds, and are repeated on the order of milliseconds, the voltage of node 1802 is only pulled down for very brief periods of time (e.g., with a very low duty cycle). As a result, such operations will not adversely affect the output of light source 618 (e.g., will not cause light source 618 to dim or flicker in any human perceivable way during the measurement periods).

Control signal 1834 is provided to light source control block 1825 as a substantially continuous control signal (e.g., based on a substantially continuous user control signal determined based on the position of rotatable user control 644) to control, for example, the brightness of light source 618. Light source control circuit 1825 provides a control signal 1836 in response to control signal 1834 to adjust the operation of light source 618. In some embodiments, light source control circuit 1825 may be implemented in the same or similar manner as light source control circuit 125 described herein.

Conditioning circuit 1850 is connected to node 1802 (not shown in FIG. 18) and provides a conditioned (e.g., filtered and regulated) voltage to processor 1821 over connection 1803. In this regard, conditioning circuit 1850 operates to remove current/voltage oscillations 1890 from the power supply provided to processor 1821 (e.g., to ensure reliable operation of processor 1821). In some embodiments, conditioning circuit 1820 may be implemented in the same or similar manner as conditioning circuit 208 and/or various filters described herein. FIG. 20 illustrates an example embodiment of conditioning circuit 1850. As shown, conditioning circuit 1850 includes various components to filter and regulate the battery voltage received from node 1802, and provide a conditioned voltage to processor 1821 over connection 1803. Conditioning circuit 1850 also provides a regulated 3 volt power supply voltage (e.g., low voltage) to node 1851.

Amplitude detection circuit 1870 is used to detect whether switch 640 is depressed. FIG. 19 illustrates an example embodiment of amplitude detection circuit 1870. As shown, amplitude detection circuit 1870 is connected to battery node 1802, filtered voltage node 1803, and low voltage node 1851. In response to the voltage at node 1802, amplitude detection circuit 1870 generates a switched user control signal (e.g., on/off) at node 1910. This signal is provided to processor 1821 to determine the state of switch 640 (e.g., engaged or disengaged).

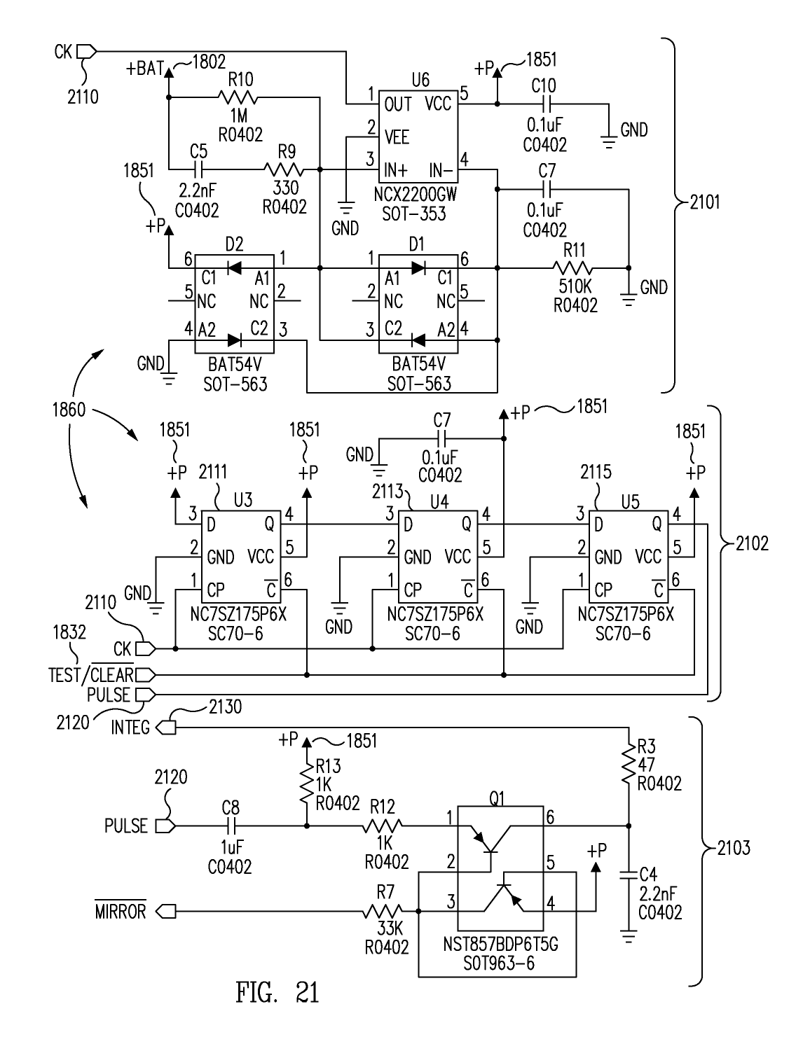

Ringing measurement circuit 1860 is used to generate a substantially continuous user control signal at a node 2130 (see FIG. 21) based on the position of rotatable user control 644 (e.g., the inductance exhibited by variable inductor 679). FIG. 21 illustrates an example embodiment of ringing measurement circuit 1860. As shown, ringing measurement circuit 1860 includes circuits 2101, 2102, and 2103, which are interconnected through various labeled nodes.

Circuit 2101 generates a pulse signal (labeled “CK”) at node 2110 in response to each rising edge of oscillating signal 1890 detected at node 1802. For example, in some embodiments, when switch 1816 is closed, the voltage at node 1802 will be pulled down (e.g., by the charging of capacitor 1814). As the voltage is pulled back up by battery 626, the rising edge of the oscillating signal 1890 as detected at node 1802 will cause circuit 2101 to output a clock pulse at node 2110. Accordingly, as signal 1890 oscillates, the rising edges will cause circuit 2101 to provide a train of clock pulses at node 2110.

Circuit 2102 receives the clock pulses from node 2110 and uses them to clock flip flops 2111, 2113, and 2115. Flip flops 2111, 2113, and 2115 are initially set to logic low values (e.g., by control signal 1832 labeled TEST/CLEAR provided by processor 1821). Thus, flip flop 2115 will initially provide logic low values to node 2120 (labeled “PULSE”) until the first clock pulse cycles through to flip flop 2115, at which time flip flop 2115 and node 2110 will switch to a logic high value. Thus, circuit 2102 effectively operates to count the first three oscillations of signal 1890 at node 1802 and provide a logic high value to node 2120 beginning when the third oscillation occurs, and continuing until flip flops 2111, 2113, and 2115 are cleared by processor 1821 (e.g., at the end of a measurement period).

Circuit 2103 operates to integrate the signal received at node 2120 during a measurement period. In this regard, circuit 2103 provides an integration signal at node 2130 which is proportional to the frequency of oscillations of signal 1890. The integration signal at node 2130 can be provided to processor 1821 for use as a substantially continuous user control signal.

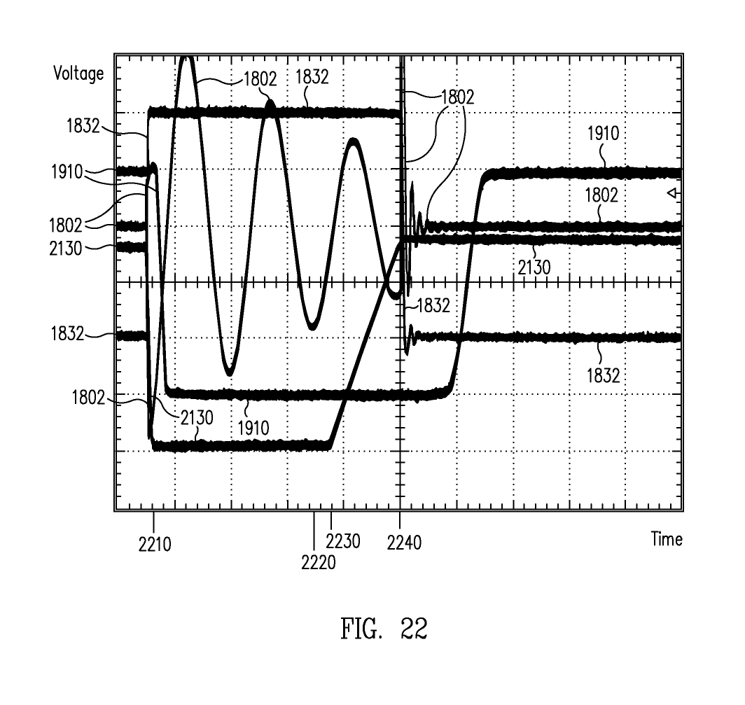

The operation of control circuit 1810 can be further understood with reference to the plots set forth in FIGS. 22-24. In this regard, each of FIGS. 22-24 illustrates various signals during one measurement period performed by control circuit 1810 under different conditions.

For example, FIG. 22 is plot of voltage versus time of various signals of lighting device 600 when the variable inductor 679 is configured in a low inductance position based on the position of the rotatable user control 644 in accordance with an embodiment of the disclosure. Also in FIG. 22, switch 640 is open (e.g., not engaged by the user).

At time 2210, processor 1821 switches control signal 1832 to close switch 1816. This causes the voltage at node 1802 to begin oscillating. As discussed, the frequency of such oscillations depends primarily on the inductance of variable inductor 679 (e.g., set at a low inductance in the plot of FIG. 22) and the capacitance of capacitor 1814. As also discussed, each rising edge of the voltage at node 1802 causes circuit 2101 to provide a pulse (e.g., at node 2110) which clocks flip flops 2111, 2113, and 2115 of circuit 2102.

The voltage at node 1802 reaches a third minimum value at time 2220. Shortly thereafter (e.g., dependent on particular circuit implementations), the third rising edge exhibited at node 1802 results in circuit 2102 providing a logic high value to circuit 2103. As a result, circuit 2103 begins integrating the logic high value of node 2120 and provides a rising integration signal 2130 at time 2230. As shown in FIG. 22, the integration continues until control signal 1832 opens switch 1816 at time 2240, which completes the measurement period.

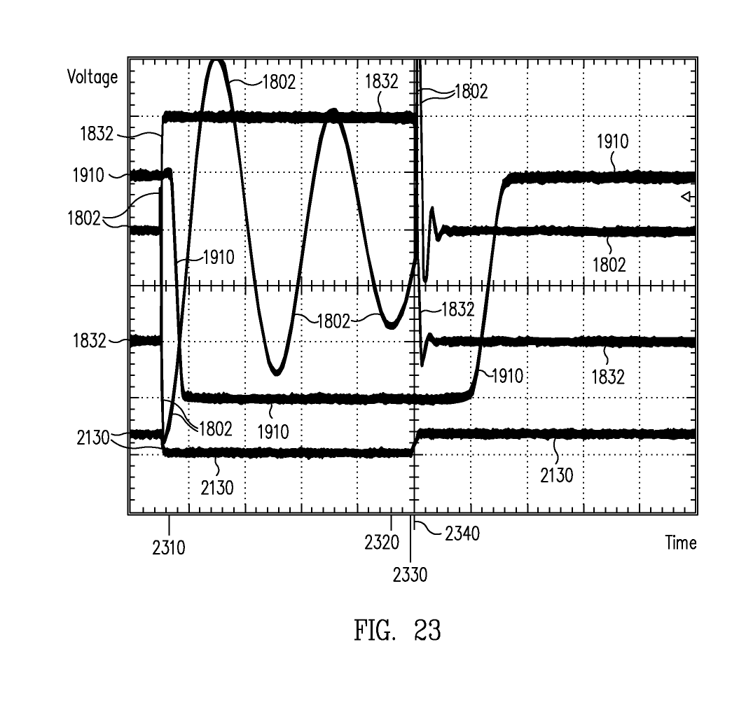

Thus, the final value (e.g., voltage) of the integration signal is proportional to the frequency of oscillations exhibited at node 1802. For example, slower oscillations will cause the third rising edge to occur later at node 1802, resulting in a shorter integration time and a proportionally smaller final value (e.g., voltage) of the integration signal (see FIG. 23). As discussed, the frequency of the oscillations at node 1802 is dependent on the value of variable inductor 679. Accordingly, the final value of the integration signal can be provided to processor 1821 as a control signal corresponding to the user's selected orientation of the rotatable user control 644 (e.g., the position of which adjusts the inductance of variable inductor 679 through the rotation of ring 646 relative to magnetic coil 674). For example, the voltage of the integration signal at node 2130 may be periodically sampled using an analog-to-digital converter (e.g., provided by processor 1821 or otherwise), such as at the end of each measurement period.

By repeatedly cycling switch 1816 and measuring/sampling the resulting signals (e.g., in repeated measurement periods as discussed), the value of the control signal provided by the integration signal can vary over time as the user adjusts the position of rotatable user control 644. Indeed, by repeating the measurement periods at relatively short intervals which cannot be readily perceived by the user (e.g., on the order of milliseconds as discussed), the sampled values of the integration signal may be used by processor 1821 as a substantially continuous user control signal (e.g., providing updated control signal values continuously and/or at such relatively short intervals to control brightness and/or other aspects of light source 618 or lighting device 600).

As also shown in FIG. 22, while switch 640 is open, the switched user control signal provided by amplitude detection circuit 1870 at node 1910 exhibits a relatively low voltage at time 2240 which corresponds to the end of the measurement period. This switched user control signal can be provided to processor 1821 (e.g., through appropriate sampling or otherwise) at the end of each measurement period (e.g., to control on/off state, maximum brightness, and/or other aspects of light source 618 or lighting device 600).

FIG. 23 is plot of voltage versus time of various signals of lighting device 600 when the variable inductor 679 is configured in a high inductance position based on the position of the rotatable user control 644 in accordance with an embodiment of the disclosure. Also in FIG. 23, switch 640 is open (e.g., not engaged by the user).

As shown in FIG. 23, the measurement period begins at time 2310. However, the voltage at node 1802 reaches a third minimum value at time 2320 which occurs significantly later than time 2220 of FIG. 22 (e.g., due to the slower oscillation frequency exhibited at node 1802 due to the high inductance provided by variable inductor 679). As a result, circuit 2103 begins providing the rising integration signal 2130 at time 2330 which is much later than time 2230 of FIG. 22. As a result, the integration only occurs for a very short time period (e.g., from time 2330 to time 2340), which results in a proportionally smaller voltage for the integration signal, and thus the control signal value associated with the rotatable user control 644.

As also shown in FIG. 23, while switch 640 is open, the switched user control signal provided by amplitude detection circuit 1870 at node 1910 exhibits a relatively low voltage at time 2340, which is similar to that of FIG. 22.

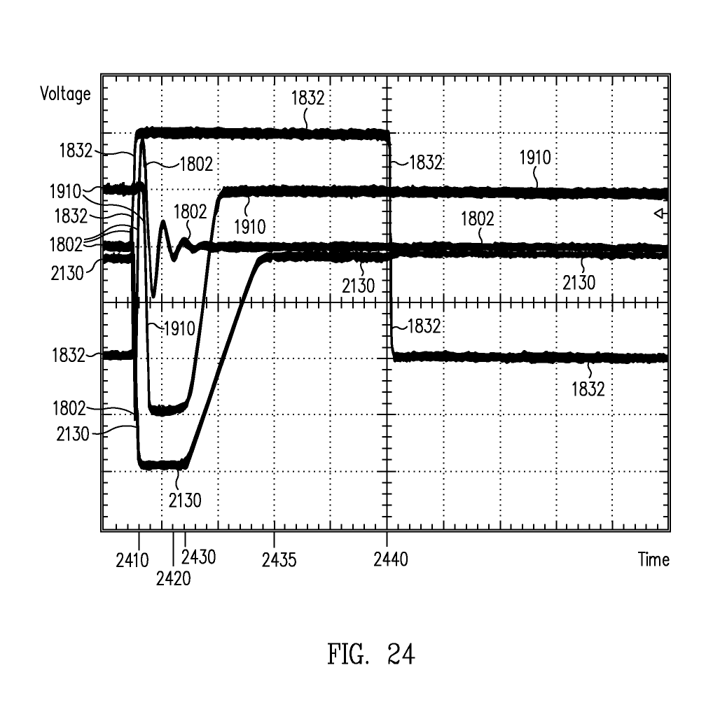

FIG. 24 is plot of voltage versus time of various signals of lighting device 600 when switch 640 is engaged to bypass variable inductor 679 in accordance with an embodiment of the disclosure. While switch 640 is so engaged, the inductance previously provided by variable inductor 679 is effectively removed from circuit 1800, resulting in faster oscillations exhibited at node 1802 during the measurement period (e.g., corresponding to a period from time 2410 to time 2440). In particular, node 1802 exhibits a third minimum at time 2420 which occurs much sooner than times 2220 and 2320 of FIGS. 22 and 23. The integration signal at node 2130 begins rising at time 2430 in response thereto, and reaches a maximum voltage at time 2435.

In contrast to FIGS. 22 and 23, while switch 640 is closed, the switched user control signal provided by amplitude detection circuit 1870 at node 1910 exhibits a relatively high voltage at the end of the measurement period (e.g., time 2440). Thus, the low or high voltage exhibited at node 1910 may be changed by the user's operation of switch 640, and may be provided to processor 1821 at the end of each measurement period as a switched user control signal to control light source 618 or lighting device 600 as discussed.

Where applicable, various embodiments provided by the disclosure can be implemented using hardware, software, or combinations of hardware and software. Also where applicable, the various hardware components and/or software components set forth herein can be combined into composite components comprising software, hardware, and/or both without departing from the spirit of the disclosure. Where applicable, the various hardware components and/or software components set forth herein can be separated into sub-components comprising software, hardware, or both without departing from the spirit of the disclosure. In addition, where applicable, it is contemplated that software components can be implemented as hardware components, and vice-versa.

Software in accordance with the disclosure, such as program code and/or data, can be stored on one or more machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the disclosure. It should also be understood that numerous modifications and variations are possible in accordance with the principles of the disclosure. Accordingly, the scope of the invention is defined only by the following claims.

What is claimed is:

1. A lighting device comprising:
a tail cap;
a battery terminal; and
a variable inductor mounted substantially in the tail cap and electrically connected in series with the battery terminal.

2. The lighting device of claim 1, further comprising a user control adapted to adjust an inductance exhibited by the variable inductor.

3. The lighting device of claim 2, wherein:
the variable inductor comprises a ferrous structure and a magnetic coil at least partially disposed within the ferrous structure; and
the user control is adapted to move the ferrous structure relative to the magnetic coil to adjust the inductance.

4. The lighting device of claim 3, wherein the ferrous structure comprises a ring adapted to be rotated relative to the magnetic coil in response to actuation of the user control.

5. The lighting device of claim 4, wherein:
the magnetic coil comprises a wire coil and a core; and
the ring has a substantially elliptical inner circumfery and is adapted to rotate between:
a first position in which a major axis of the elliptical inner circumfery of the ring is disposed coaxially with a long axis of the core, and
a second position in which a minor axis of the elliptical inner circumfery of the ring is disposed coaxially with the long axis of the core.

6. The lighting device of claim 2, wherein:
the lighting device is a flashlight; and
the user control is a rotatable knob disposed at the tail cap.

7. The lighting device of claim 1, further comprising:
a light source; and
a control circuit adapted to generate a substantially continuous control signal and adjust operation of the light source in response thereto, the substantially continuous control signal having a value proportional to an inductance exhibited by the variable inductor.

8. The lighting device of claim 7, further comprising a switch adapted to selectively introduce an oscillating signal in the variable inductor, wherein the control circuit is adapted to generate the substantially continuous control signal in response to the oscillating signal.

9. The lighting device of claim 8, wherein the control circuit is adapted to:
detect a minimum number of oscillations of the oscillating signal occurring during a measurement period;
integrate a voltage during the measurement period after the minimum number of oscillations are detected;
sample the integrated voltage at the end of the measurement period to provide a value of the substantially continuous control signal; and
repeat the detect, integrate, and sample operations for a plurality of oscillating signals introduced by the switch in a corresponding plurality of measurement periods to generate the substantially continuous control signal.

10. The lighting device of claim 1, further comprising:
a user operable switch configured to selectively bypass the variable inductor;
a light source; and
a control circuit adapted to:
generate a switched control signal in response to the bypass, and
adjust operation of the light source in response to the switched control signal.

11. The lighting device of claim 1, further comprising:
a user operable switch configured to selectively connect the variable inductor in series with the battery terminal in response to a first actuation and selectively bypass the variable inductor in response to a second actuation;
a light source; and
a control circuit adapted to:
generate a first switched control signal in response to the first actuation,
adjust operation of the light source in response to the first switched control signal,
generate a second switched control signal in response to the second actuation, and
adjust operation of the light source in response to the second switched control signal.

12. A method comprising:
providing a lighting device comprising:
a tail cap,
a battery terminal,
a variable inductor mounted substantially in the tail cap and electrically connected in series with the battery terminal, and
a user control; and
receiving an actuation of the user control to adjust an inductance exhibited by the variable inductor.

13. The method of claim 12, wherein:
the variable inductor comprises a ferrous structure and a magnetic coil at least partially disposed within the ferrous structure; and
the actuation of the user control moves the ferrous structure relative to the magnetic coil to adjust the inductance.

14. The method of claim 13, wherein:
the ferrous structure comprises a ring; and
the actuation of the user control rotates the ring relative to the magnetic coil.

15. The method of claim 14, wherein:
the magnetic coil comprises a wire coil and a core;
the ring has a substantially elliptical inner circumfery; and
the actuation of the user control rotates the ring between:
a first position in which a major axis of the elliptical inner circumfery of the ring is disposed coaxially with a long axis of the core, and
a second position in which a minor axis of the elliptical inner circumfery of the ring is disposed coaxially with the long axis of the core.

16. The method of claim 12, wherein:
the lighting device is a flashlight; and
the user control is a rotatable knob disposed at the tail cap.

17. The method of claim 12, further comprising:
generating a substantially continuous control signal having a value proportional to the inductance; and
adjusting operation of a light source of the lighting device in response to the substantially continuous control signal.

18. The method of claim 17, wherein the generating comprises:
selectively introducing an oscillating signal in the variable inductor; and
providing the substantially continuous control signal in response to the oscillating signal.

19. The method of claim 18, wherein the providing the substantially continuous control signal comprises:
detecting a minimum number of oscillations of the oscillating signal occurring during a measurement period;
integrating a voltage during the measurement period after the detecting;
sampling the integrated voltage at the end of the measurement period to provide a value of the substantially continuous control signal; and
repeating the detecting, integrating, and sampling for a plurality of oscillating signals introduced by the switch in a corresponding plurality of measurement periods to generate the substantially continuous control signal.

20. The method of claim 12, further comprising:
receiving an actuation of a user operable switch;
selectively bypassing the variable inductor in response to the actuation of the user operable switch;
generating a switched control signal in response to the bypassing; and
adjusting operation of a light source of the lighting device in response to the switched control signal.

21. The method of claim 12, further comprising:
receiving a first actuation of a user operable switch;
selectively connecting the variable inductor in series with the battery terminal in response to the first actuation;
generating a first switched control signal in response to the first actuation;
adjusting operation of a light source of the lighting device in response to the first switched control signal;
receiving a second actuation of the user operable switch;
selectively bypassing the variable inductor in response to the second actuation;
generating a second switched control signal in response to the second actuation; and
adjusting operation of the light source in response to the second switched control signal.
